(19) United States
(12) Patent Application Publication
(10) Pub. No.: US 2026/0127211 A1
(43) Pub. Date: May 7, 2026

(54) DOCUMENT INGESTION SYSTEM WITH METADATA TAGGING TO GENERATE A SUMMARIZED DOCUMENT USING INTEGRATED PROGRAMMATIC AND SPECIALIZED GUIDED AND CONSTRAINED ARTIFICIAL INTELLIGENCE

(71) Applicant: Trilogy Enterprises, Inc., Austin, TX (US)

(72) Inventors: Arthur Michel, Brooklyn, NY (US); Benji Bizzell, Asheville, NC (US); Neeraj Gupta, Austin, TX (US)

(73) Assignee: Trilogy Enterprises, Inc., Austin, TX (US)

(21) Appl. No.: 19/378,072

(22) Filed: Nov. 3, 2025

Related U.S. Application Data
(60) Provisional application No. 63/714,909, filed on Nov. 1, 2024.

(51) Int. Cl. G06F 16/34; G06F 16/334; G06F 40/205; G06F 40/289; G06F 40/30; G06N 5/02

(52) U.S. Cl. CPC G06F 16/345; G06F 16/3347; G06F 40/205; G06F 40/289; G06F 40/30; G06N 5/02

(57) ABSTRACT

A document ingestion system and process that manages documents and generates a summarized document using a user query for ingesting and summarizing documents based on a user query is disclosed. The document ingestion process involves ingesting documents from local or cloud storage and analyzing them using natural language processing (NLP) techniques. The analysis assigns metadata tags and extracts relevant content, which is then converted into vectorized embeddings for efficient retrieval. The embedded document content is divided into smaller, coherent chunks based on semantic structure, facilitating granular processing. Each chunk is assigned a priority score based on content, context, and relevance, ensuring that the most important information is utilized. A prompt is generated to guide an AI engine in producing a summarized document or answering the user's query. The AI engine processes the prioritized content and generates a summary based on the user's query and ingested documents.

### CROSS-REFERENCE TO RELATED APPLICATION(S)

This application claims the benefit under 35 U.S.C. § 119 (e) and 37 C.F.R. § 1.78 of U.S. Provisional Application No. 63/714,909, which is incorporated by reference in its entirety.

### FIELD OF THE INVENTION

The present invention generally relates to the field of electronics, and more specifically to a document ingestion system that comprises meta-tagging and classifying the ingested documents based on the priority value provided to the corresponding document, and generating a knowledge graph based on the classified documents. A summary or report of the documents is generated based on the classified documents and knowledge graph.

### BACKGROUND OF THE INVENTION

The conventional technology in document management systems primarily focused on basic storage, retrieval, and sometimes categorization of documents. Historically, these systems were often limited to manual tagging processes or rudimentary automatic categorization based on simple text analysis. In these early systems, document management was mainly about providing a digital repository where users could store and retrieve files. The systems were often designed with minimal intelligence and lacked the ability to understand or process documents at a deeper level.

Initially, document management systems were built to replicate the function of physical filing cabinets, allowing users to create folders, store documents, and search for them using basic metadata like the document name or creation date. However, this was often inefficient because the systems could not understand the context or meaning of the content in the documents, leading to limited success in retrieving relevant information.

For instance, a legal firm using a traditional document management system might store thousands of contracts, case files, and client communications. If a lawyer needed to find all documents related to a particular case, they would have to rely on keyword searches or manually browse through folders to find relevant files. This often resulted in missed documents or incomplete searches.

Moreover, the traditional systems were not equipped to handle large datasets efficiently. As organizations began to accumulate more digital files, the systems became increasingly unwieldy and difficult to navigate.

Historically, document management systems relied heavily on manual tagging and categorization to organize large volumes of data. This process was extremely labor-intensive and prone to human error, as it required employees to review individual documents and assign relevant tags or categories. The lack of automation in this process made it difficult to efficiently manage growing datasets. Furthermore, the larger the dataset, the more inefficient the process became, as keeping track of all the assigned tags manually was nearly impossible. The lack of scalability in manual processes posed significant challenges to organizations dealing with rapidly growing digital archives. Additionally, there was always the risk of human error, whether it was tagging documents incorrectly or failing to tag them at all, which could lead to important documents being lost in the system or misplaced in irrelevant categories.

Moreover, basic automatic categorization systems struggled with ambiguous language. These limitations significantly impacted the accuracy of document retrieval. Users often found themselves sifting through incorrectly categorized documents to find the information they needed. The shortcomings of keyword-based systems also made it difficult to maintain consistency, as documents with similar content could be categorized in different ways based on the specific wording used.

Despite these technological advancements, many document management systems remained outdated, still relying on manual or basic automatic categorization methods. These systems were unable to take full advantage of the potential offered by modern AI-driven tools. As a result, there was a significant gap in the market for systems that could not only manage documents but also provide advanced categorization, real-time knowledge graph generation, and contextual understanding of the content.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary document ingestion system that manages documents and generates a summarized document using a user query.

FIG. 2 depicts an exemplary document ingestion process that manages documents and generates a summarized document using a user query.

FIG. 3 depicts an exemplary ingested documents processing system, which is an embodiment of the document ingestion system that manages documents and generates a summarized document using a user query of FIG. 1.

FIG. 4 depicts an exemplary user interface where the user can either directly enter the query or ingest documents along with the query to get the result as per user requirements.

FIG. 5 depicts an exemplary user interface that allows the user to change the settings of the online document management platform.

FIG. 6 depicts an exemplary user interface where the user can query to generate a summarized document and access the application code used by the document processing module to generate that summarized document.

FIGS. 7 and 8 depict exemplary user interfaces displaying multiple API bundles using which the documents are ingested to the document processing module.

FIG. 9 depicts an exemplary user interface that allows users to enter the query, for which the user needs a solution.

FIG. 10 depicts an exemplary user interface where the metadata-tagged and categorized documents are displayed to the user.

FIG. 11 depicts an exemplary vector database that provides the details of the metadata divided into chunks.

FIG. 12 depicts an exemplary knowledge graph generated based on the ingested documents and a user query.

FIG. 13 depicts an exemplary scenario where the user queries the online document management platform to generate an application using the ingested course details.

FIG. 14 depicts an exemplary scenario where the user queries the online document management platform to generate a summary of the ingested document.

FIG. 15 depicts an exemplary network environment in which the document ingestion system that manages documents and generates a summarized document by utilizing a user query of FIG. 1 and the document ingestion system that manages documents and generates a summarized document by utilizing a user query of FIG. 2 may be practiced.

FIG. 16 depicts an exemplary computer system.

### DETAILED DESCRIPTION

A document ingestion system that manages documents and generates a summarized document using a user query is disclosed. The document ingestion system includes an online document management platform, which is operatively coupled to a document processing module. A data ingestor is integrated within the document processing module which ingests the documents uploaded by the user either through local storage or cloud storage. The documents are ingested to the data ingestor via., API bundles which provides the link of the folder where the documents are present. The ingested documents are then provided to an analyzer, integrated within the document processing module, which parses the ingested documents and provides a metadata tag to the ingested documents based on the multiple categories, including, content, context, semantic analysis, and so on.

The analyzed metadata tagged documents are then converted into a vector database using an embedding module which converts the tagged documents into numerical values. The embedded data is then divided into chunks using a chunked module. The chunked documents are provided a priority score based on the relevance, context, and freshness of the documents using a ranking module. Based on these prioritized documents and a prompt structure generated by a prompt engineer, a prompt is generated by the prompt generator to guide the AI engine to generate a response using a document generator. The response depends on the user's query, and the set of the prioritized documents. For instance, the response may include summary of documents, generation of an application, or asking for insights from the ingested documents.

The document ingestion system offers significant advantages by automating the ingestion, analysis, and summarization of documents, reducing the need for manual tagging and eliminating human error. The document ingestion system uses advanced natural language processing (NLP) techniques to analyze documents, assign accurate metadata tags, and generate vectorized embeddings that allow for more precise categorization and retrieval. The integration of real-time knowledge graph generation further enhances the ability of the document ingestion system to map relationships between documents and concepts, providing deeper contextual understanding. By prioritizing and chunking documents based on content and relevance, the document ingestion system ensures efficient processing, allowing users to retrieve concise, relevant summaries and answers to queries.

The system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. Conventional approaches often do not recognize the technical capabilities of an engineered prompt to guide and constrain an AI engine to generate a desired output. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

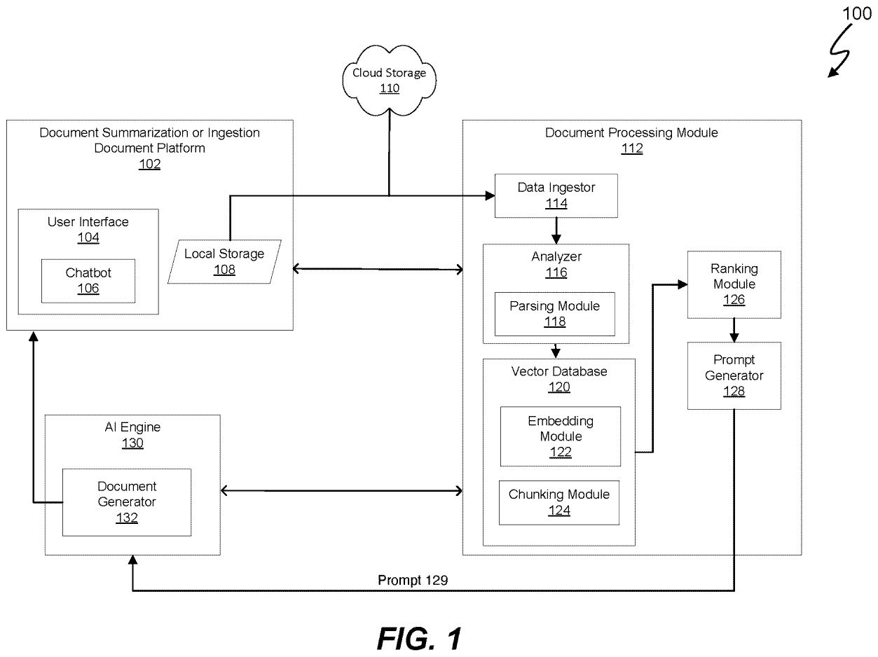

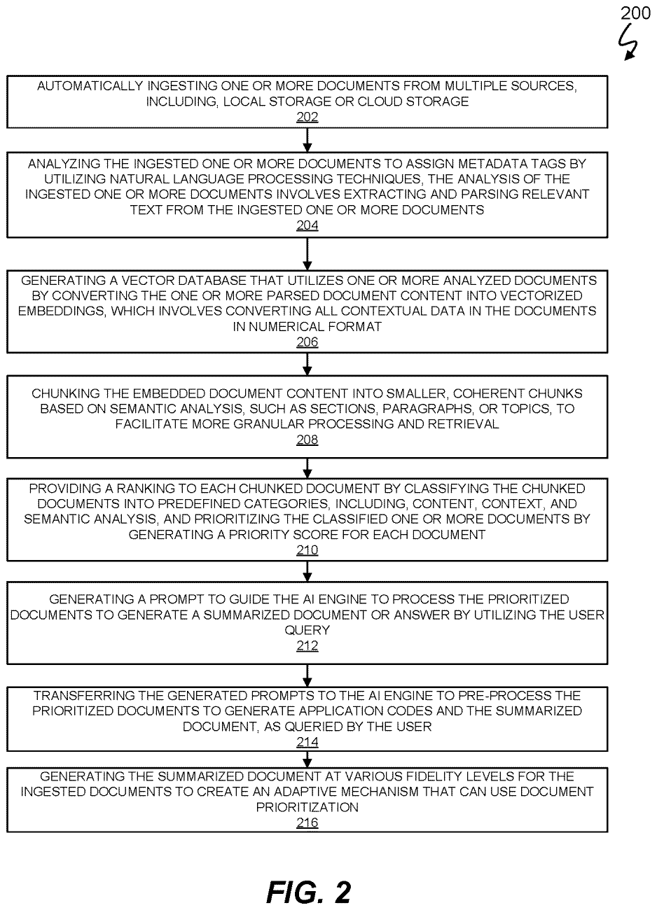

FIG. 1 depicts an exemplary document ingestion system 100 that manages documents and generates a summarized document using a user query. FIG. 2 depicts an exemplary document ingestion process 200 that manages documents and generates a summarized document using a user query, utilized by the document ingestion system 100.

Referring to FIGS. 1 and 2, in operation 202, a data ingestor 114 automatically ingests one or more documents from multiple sources, including local storage 108 or cloud storage 110.

The data ingestor 114 is integrated within a document processing module 114, operatively coupled to an online document management platform 102. This integration allows seamless interaction between document ingestion and processing within the online document management platform 102. The data ingestor 114 is a key component responsible for automatically ingesting documents from various sources, including local storage 108 and cloud storage 110. The data ingestor 114 retrieves and processes documents from these sources, ensuring that they are accessible within the document processing module 112. The data ingestion supports multiple document formats such as PDFs, text files, spreadsheets, emails, messages, JSON, and other common data types. This flexibility allows the data ingestor 114 to handle a wide range of data.

Users can provide a link to a folder, specifying its location within the online document management platform 102, whether the folder resides in local storage 108 or cloud storage 110. Once the link is provided, the data ingestor 114 uses API bundles 134 to facilitate secure communication between the local storage 108 or cloud storage 110 and the data ingestor 114. These API bundles 134 act as connectors, allowing the data ingestor 114 to access files from both local sources 108 and cloud sources 110. For instance, local storage 108 may use APIs to access file directories, while cloud storage 110 APIs connect to services like AWS S3, Google Drive, or Microsoft OneDrive.

Through these API bundles 134, the data ingestor 114 can pull documents directly from the linked folder provided by the user, regardless of the storage location or document format. Once ingested, the documents are passed to the document processing module 112 for further actions such as indexing, categorization, or content extraction.

An exemplary code used during the data ingestion of the document ingestion system 100 that manages documents and generates a summarized document using a user query is given below:

```
import base64
from io import BytesIO
import logging
import re
import asyncio
import traceback
from typing import Dict, Any, List
from app.services.gdrive_ingest_service import gdrive_ingest_service
from app.core.config import settings
import PyPDF2
from app.models.pydantic_models import IngestLocalFileRequest, IngestRequest,
IngestResponse, IngestStats, ManifestItem
from app.services.chunking_service import chunking_service
from app.services.embedding_service import embedding_service
from app.services.indexing_service import indexing_service
from app.services.library_service import library_service
logger = logging.getLogger(“antenna.services.ingest”)
class IngestService:
  async def process_gdrive_ingest(self, request: IngestRequest, namespace:
str, manifest: List[Dict[str, Any]], account_id: str) −> IngestResponse:
    logger.info(f“Processing Google Drive ingest: {request}”)
    try:
      #Flag to process the files
      process=True
      # Check if the namespace already exists
      existing_count = await
indexing_service.get_namespace_stats(namespace)
      if existing_count > 0:
        logger.info(f“Namespace {namespace} already exist.Records:
{existing_count}”)
        process=False
        await library_service.add_library_item(namespace,
[ManifestItem(**item) for item in manifest], account_id)
        return IngestResponse(
            status=“success”,
            message=f“Namespace {namespace} already
exist.Records: {existing_count}”,
            manifest=manifest,
            index_reference=namespace
        )
      if process:
        # Process files concurrently
        processed_files = await
asyncio.gather(*[self.process_single_file(file_info, namespace) for file_info
in manifest])
        # Filter out None values (failed files) and flatten the list
        processed_files = [file for sublist in processed_files if
sublist for file in sublist]
        await library_service.add_library_item(namespace,
[ManifestItem(**item) for item in manifest], account_id)
        return IngestResponse(
          status=“success”,
          message=f“Processed {len(processed_files)} files”,
          manifest=manifest,
          index_reference=namespace,
        )
    except Exception as e:
      logger.error(f“Error in Google Drive ingest: {str(e)}”)
      raise
  async def process_single_file(self, file_info: Dict[str, Any], namespace:
str) −> List[str]:
    try:
      content = await
gdrive_ingest_service.download_file_content(file_info)
      if isinstance(content, str):
        chunks = chunking_service.chunk_content(content)
        embeddings = await embedding_service.embed_chunks(chunks)
        chunks_and_embeddings = list(zip(chunks, embeddings))
        await
indexing_service.index_embeddings(chunks_and_embeddings, namespace,
file_info)
      elif isinstance(content, dict):
        for sheet_name, sheet_data in content.items( ):
          header = sheet_data.get(‘header’, [ ])
          sheet_content = sheet_data.get(‘content’, ‘’)
          full_content = ‘,’.join(header) + ‘\n’ + sheet_content if
header else sheet_content
          chunks = chunking_service.chunk_content(full_content)
          if chunks :
            logger.info(f “Processing sheet ‘{sheet_name}’ in file
‘{file_info[‘name’]}’”)
            embeddings = await
embedding_service.embed_chunks(chunks)
            chunks_and_embeddings = list(zip(chunks, embeddings))
            sheet_file_info = {**file_info, ‘sheet_name’:
sheet_name}
            await
indexing_service.index_embeddings(chunks_and_embeddings, namespace,
sheet_file_info)
          else:
            logger.warning(f“No content found for sheet
‘{sheet_name}’ in file {file_info[‘name’]}”)
      else:
        logger.warning(f“Unsupported content type for file
{file_info[‘name’]}”)
        return [ ]
      return [file_info[‘name’]]
    except Exception as e:
      logger.error(f“Error processing file {file_info[‘name’]}:
{str(e)}”)
      logger.error(f“Traceback: {traceback.format_exc( )}”)
      return [ ]
  async def get_namespace_stats(self, namespace: str) −> IngestStats:
    try:
      # Get the record count from Pinecone for the given namespace
      record_count = await
indexing_service.get_namespace_stats(namespace)
      logger.info(f“Record count for namespace {namespace}:
{record_count}”)
      if record_count is None:
        return IngestStats(
          status=“not_found”,
          message=f“No records found in namespace: {namespace}”,
          record_count=0
        )
      return IngestStats(
        status=“success”,
        message=f“Found {record_count} records in namespace:
{namespace}”,
        record_count=record_count
        )
    except Exception as e:
      logger.error(f“Error checking indexing status for namespace
{namespace}: {str(e)}”)
      return IngestStats(
        status=“error”,
        message=f“An error occurred while checking the indexing
status: {str(e)}”,
        record_count=0
      )
  async def get_data(self, request: IngestRequest, namespace: str,
folder_id: str) −> Dict[str, Any]:
    logger.info(f“Getting data for Google Drive ingest: {request}”)
    try:
      if not await gdrive_ingest_service.validate_folder(folder_id):
        raise ValueError(“Invalid folder ID”)
      manifest = await
gdrive_ingest_service.get_files_recursive(folder_id)
      return {
        “manifest”: manifest,
        “index_reference”: namespace,
      }
    except Exception as e:
      logger.error(f“Error in Google Drive ingest: {str(e)}”)
      raise
  def _extract_text_from_base64_pdf(self, base64_pdf: str) −> str:
    pdf_data = base64.b64decode(base64_pdf)
    pdf_stream = BytesIO(pdf_data)
    reader = PyPDF2.PdfReader(pdf_stream)
    extracted_text = “”
    for page in reader.pages:
      extracted_text += page.extract_text( )
    return extracted_text
  async def process_local_file_ingest(self, request:
IngestLocalFileRequest, namespace: str, manifest: List[Dict[str, Any]],
account_id: str) −> IngestResponse:
    logger.info(f“Processing local file ingest: {request.file_name}”)
    try:
      if(request.mime_type == “application/pdf”):
        content = self._extract_text_from_base64_pdf(request.base_64)
      else:
        raise ValueError(“Unsupported file type”)
      chunks = chunking_service.chunk_content(content)
      embeddings = await embedding_service.embed_chunks(chunks)
      chunks_and_embeddings = list(zip(chunks, embeddings))
      file_info = {
        “id”: manifest[0].get(“id”),
        “name”: request.file_name,
        “mimeType”: request.mime_type
      }
      await indexing_service.index_embeddings(chunks_and_embeddings,
namespace, file_info)
      await library_service.insert_manifest_item(namespace,
ManifestItem(**manifest[0]), account_id)
      return IngestResponse(
        status=“success”,
        message=“Processed local file”,
        manifest=manifest,
        index_reference=namespace
      )
    except ValueError as ve:
      logger.error(f“Validation error in local file ingest: {str(ve)}”)
      raise ve
    except Exception as e:
      logger.error(f“Error processing local file ingest: {str(e)}”)
      raise
ingest_service = IngestService( )
```

The prompt defines an IngestService class responsible for handling the ingestion of files from Google Drive and local sources 108 into the data ingestor 114 for indexing. The class relies on several external services, including gdrive_ingest_service, chunking_service, embedding_service, indexing_service, and library_service.

The process_gdrive_ingest function manages the ingestion process for Google Drive files. The process_gdrive_ingest function first checks whether the specified namespace already exists. If it does, the provided files are added to the existing namespace without reprocessing them. If the namespace is new, it processes the files concurrently, extracting content from each, breaking it into smaller chunks, embedding the content, and indexing it within the namespace. The namespace is defined as the title of the ingested file provided by the user.

Additionally, the data ingestor 114 handles different file types, such as text documents and spreadsheets, and ensures that any errors encountered during processing are logged. The process_single_file is dedicated to processing individual files by extracting content. The prompt is further configured to filter out the documents which have no value i.e., the empty documents. Also, the prompts take the documents from a vector database, which is explained in detail in the operation 206.

In operation 204, an analyzer 116 analyzes the ingested one or more documents to assign metadata tags that utilize natural language processing techniques. The analysis of the ingested one or more documents involves extracting and parsing relevant text from the ingested one or more documents using a parsing module 118.

The analyzer 116 is integrated within the document processing module 116 and utilizes Natural Language Processing (NLP) techniques to analyze and tag ingested documents received from the data ingestor 114. The analyzer 116 performs a detailed examination and metadata tagging of the documents using NLP.

Once the documents are received by the analyzer 116, they undergo a multi-step analysis. First, a parsing module 118, integrated within the analyzer 116, extracts and parses relevant text from the documents. The parsing module 118 supports various formats, including PDFs, text files, and spreadsheets, ensuring that a wide range of document types can be processed. The parsing module 118 works by extracting the text content, and preparing them for further analysis by the NLP algorithms.

The analyzer 116 then applies advanced NLP techniques to the extracted content which identifies and extracts key terms, entities, and relationships within the documents, such as names of people, places, dates, and other critical information, as queried by the user. The analysis of the documents not only focuses on individual words but also seeks to understand the broader context and relationships between entities. Additionally, the analyzer 116 performs semantic analysis, which helps in understanding the deeper meaning and context of the text, to gain insight into the document's content and relevance.

Once the NLP and semantic analysis are completed, the analyzer 116 assigns metadata tags to the documents. These tags categorize the documents based on their content, making them easier to search, classify, and retrieve later. The metadata includes details about the document's key terms, entities, and contextual relevance, helping in organizing large volumes of documents more effectively. For instance, the metadata tags include tagging the documents based on the title and context of the document, say, all the documents carrying financial information of the organization are provided a specific tag. Similarly, a document related to stocks, and employee details is provided with separate tags respectively.

An exemplary code used for the analysis of the ingested documents in the document ingestion system 100 that manages documents and generates a summarized document using a user query is given below:

```
import os
import logging
import re
import string
import traceback
import pandas as pd
from concurrent.futures import ThreadPoolExecutor, as_completed
import logging
import PyPDF2
from docx import Document
from io import BytesIO
from typing import List, Dict, Any, Union
from google.oauth2 import service_account
from googleapiclient.discovery import build
from app.services.account_service import get_integration_credentials
from app.core.config import settings
logger = logging.getLogger(“antenna.services.gdrive_ingest”)
class GDriveIngestService:
  def _{——}init_{——}(self):
    credentials = None
    #get oauth credentials for google drive for this account
    #credentials = get_integration_credentials(account_id, ‘google’)
    #If account level credentials are not found, attempt to use service
account credentials
    if not credentials:
      credentials_path = os.getenv(‘GOOGLE_DRIVE_CREDENTIALS_FILE’)
      print(f“Credentials path: {credentials_path}”)
      print(f“Current working directory: {os.getcwd( )}”)
      print(f“File exists: {os.path.exists(credentials_path) if
credentials_path else ‘N/A’}”)
      if not credentials_path:
        raise ValueError(“GOOGLE_DRIVE_CREDENTIALS_FILE environment
variable is not set”)
      if not os.path.exists(credentials_path):
        raise FileNotFoundError(f“Credentials file not found at
{credentials_path}”)
      credentials =
service_account.Credentials.from_service_account_file(
        credentials_path,
        scopes=[‘https://www.googleapis.com/auth/drive.readonly’]
      )
    self.drive_service = build(‘drive’, ‘v3’, credentials=credentials)
    self.spreadsheets_service = build(‘sheets', ‘v4’,
credentials=credentials)
  async def validate_folder(self, folder_id: str) −> bool:
    try:
      folder = self.drive_service.files( ).get(fileId=folder_id,
fields=“mimeType”).execute( )
      return folder[‘mimeType’] == ‘application/vnd.google-apps.folder’
    except Exception as e:
      logger.error(f“Error validating folder: {e}”)
      return False
  async def get_files_recursive(self, folder_id: str) −> List[Dict[str,
Any]]:
    manifest = [ ]
    await self._get_files_recursive_helper(folder_id, manifest)
    return manifest
  async def _get_files_recursive_helper(self, folder_id: str, manifest:
List[Dict[str, Any]]) −> None:
    query = f“‘{folder_id}’ in parents and trashed = false”
    fields = “nextPageToken, files(id, name, mimeType, webViewLink,
shortcutDetails)”
    while True:
      results = self.drive_service.files( ).list(q=query, fields=fields,
pageSize=1000).execute( )
      items = results.get(‘files', [ ])
      for item in items:
        if item[‘mimeType’] == ‘application/vnd.google-apps.folder’:
          await self._get_files_recursive_helper(item[‘id’],
manifest)
        elif item[‘mimeType’] == ‘application/vnd.google-
apps.shortcut’:
          target_id = item.get(‘shortcutDetails',
{ }).get(‘targetId’)
          if target_id:
            target_file =
self.drive_service.files( ).get(fileId=target_id, fields=“id, name, mimeType,
webViewLink”).execute( )
            if target_file[‘mimeType’] ==
‘application/vnd.google-apps.folder’:
              await
self._get_files_recursive_helper(target_file[‘id’], manifest)
            else:
              manifest.append(target_file)
        else:
          manifest.append(item)
      if ‘nextPageToken’ not in results:
        break
  async def download_file_content(self, file_info: Dict[str, Any]) −>
Union[str, Dict[str, str]]:
    try:
      file_id = file_info[‘id’]
      mime_type = file_info[‘mimeType’]
      file_name = file_info.get(‘name’, ‘Unknown’)
      logger.info(f“Processing file: {file_name} (ID: {file_id}, Type:
{mime_type})”)
      if mime_type == ‘application/vnd.google-apps.document’:
        content = self.drive_service.files( ).export(fileId=file_id,
mimeType=‘text/plain’).execute( )
        return content.decode(‘utf-8’) if isinstance(content, bytes)
else content
      elif mime_type == ‘application/vnd.google-apps.spreadsheet’:
        logger.info(f“Processing Google Sheets document:
{file_name}”)
        sheets =
self.spreadsheets_service.spreadsheets( ).get(spreadsheetId=file_id).execute( )
        sheet_data = { }
        for sheet in sheets [‘sheets']:
          sheet_name = sheet[‘properties'][‘title’]
          logger.info(f“Processing sheet: {sheet_name}”)
          range_name = f“‘{sheet_name}’ !A1:ZZ”
          result =
self.spreadsheets_service.spreadsheets( ).values( ).get(
            spreadsheetId=file_id, range=range_name).execute( )
          values = result.get(‘values', [ ])
          sheet_data[sheet_name] = self._process_sheet_data(values,
sheet_name)
        logger.info(f“Processed {len(sheet_data)} sheets in
{file_name}”)
        return sheet_data
      elif mime_type == ‘application/vnd.openxmlformats-
officedocument.spreadsheetml.sheet’:
        logger.info(f“Processing Excel file: {file_name}”)
        content =
self.drive_service.files( ).get_media(fileId=file_id).execute( )
        excel_data = { }
        with BytesIO(content) as buffer:
          excel_file = pd.ExcelFile(buffer)
          for sheet_name in excel_file.sheet_names:
            logger.info(f“Processing Excel sheet: {sheet_name}”)
            df = pd.read_excel(excel_file, sheet_name=sheet_name,
header=None)
            excel_data[sheet_name] =
self._process_sheet_data(df.values.tolist( ), sheet_name)
        logger.info(f“Processed {len(excel_data)} sheets in Excel
file {file_name}”)
        return excel_data
      elif mime_type == ‘application/vnd.google-apps.presentation’:
        content = self.drive_service.files( ).export(fileId=file_id,
mimeType=‘text/plain’).execute( )
        return content.decode(‘utf-8’) if isinstance(content, bytes)
else content
      elif mime_type == ‘application/pdf’:
        content =
self.drive_service.files( ).get_media(fileId=file_id).execute( )
        return self._extract_text_from_pdf(content)
      elif mime_type == ‘application/vnd.openxmlformats-
officedocument.wordprocessingml.document’:
        content =
self.drive_service.files( ).get_media(fileId=file_id).execute( )
        return self._extract_text_from_docx(content)
      else:
        content =
self.drive_service.files( ).get_media(fileId=file_id).execute( )
        return content.decode(‘utf-8’) if isinstance (content, bytes)
else content
    except Exception as e:
      logger.error(f“Error downloading file content: {str(e)}”)
      logger.error(f“Traceback: {traceback.format_exc( )}”)
      raise
  def _convert_to_csv(self, values: List[List[Any]]) −> str:
    import csv
    from io import StringIO
    output = StringIO( )
    writer = csv.writer(output, lineterminator=‘\n’) # Specify line
terminator as ‘\n’
    writer.writerows(values)
    return output.getvalue( )
  def _process_sheet_data(self, values: List[List[Any]], sheet_name: str) −
> Dict [str, str]:
    logger.info(f“Processing data for sheet: {sheet_name}”)
    if not values:
      logger.warning(f“Sheet {sheet_name} is empty”)
      return {‘header’: [ ], ‘content’: ‘’}
    # Ensure all rows have the same number of columns
    max_columns = max(len(row) for row in values)
    padded_values = [row + [‘’] * (max_columns − len(row)) for row in
values]
    # Function to check if a row looks like a header
    def is_header_row(row):
      non_empty = [cell for cell in row if cell]
      if len(non_empty) < 2: # Require at least two non-empty cells
        return False
      # Check if the row contains mostly short strings or common header
terms
      header_pattern =
re.compile(r‘\hat{ }(id|name|date|total|sum|avg|count|key|value|type|status|code)$’
, re.I)
      return sum(1 for cell in non_empty if isinstance(cell, str) and
(len(cell) < 20 or header_pattern.match(cell))) / len(non_empty) > 0.7
    # Try to identify the header row
    header_row_index = next((i for i, row in enumerate(padded_values[:5])
if is_header_row(row)), None)
    if header_row_index is not None:
      header = [str(val).strip( ) for val in
padded_values[header_row_index]]
      data = padded_values[header_row_index + 1:]
    else:
      # Generate more descriptive column names
      header = self._generate_column_names(max_columns)
      data = padded_values
    # Convert all values to strings and join with commas
    csv_content = ‘\n’.join([‘,’.join(str(cell).replace(‘,’, ‘ ’) for
cell in row) for row in data])
    result = {
      ‘header’: header,
      ‘content’: csv_content
    }
    logger.info(f“Processed sheet {sheet_name}: {len(data)} rows,
{len(header)} columns”)
    return result
  def _generate_column_names(self, num_columns: int) −> List[str]:
    “““Generate descriptive column names when no header is detected.”””
    alphabet = list(string.ascii_uppercase)
    def get_column_letter(index):
      if index < 26:
        return alphabet[index]
      else:
        return alphabet[index // 26 − 1] + alphabet[index % 26]
    return [f“{get_column_letter(i)}_{i+1}” for i in range(num_columns)]
  def _extract_text_from_pdf(self, content: bytes) −> str:
    pdf_text = “”
    with BytesIO(content) as pdf_file:
      pdf_reader = PyPDF2.PdfReader(pdf_file)
      for page in pdf_reader.pages:
        pdf_text += page.extract_text( ) + “\n”
    return pdf_text
  def _extract_text_from_docx(self, content: bytes) −> str:
    doc_text = “”
    with BytesIO(content) as docx_file:
      document = Document(docx_file)
      for paragraph in document.paragraphs:
        doc_text += paragraph.text + “\n”
    return doc_text
gdrive_ingest_service = GDriveIngestService( )
```

The given prompt defines a GDriveIngestService class that manages the ingestion, extraction, and processing of various types of documents from Google Drive. Although the document ingestion is not only limited to Google Drive, other cloud storages 110 can also be used, like AWS S3, Microsoft One Drive, and so on. This service is integrated with Google's APIs to handle authentication, file retrieval, and content extraction. Since the use of Google Drive is made here for document ingestion, that's why Google's API is considered to provide the document to the data ingestor 114.

The initialization of the GDriveIngestService first attempts to obtain Google Drive credentials for the account. If credentials are not found, it uses a service account to authenticate. This allows the service to access Google Drive and Google Sheets APIs to interact with files. Once authenticated, the class can validate whether a specified folder exists using the validate folder, which checks if a folder ID corresponds to a valid Google Drive folder. The get_files_recursive function retrieves files from a folder and its subfolders, and explores the folder structure using the get_files_recursive_helper function, collecting information on each file, including file ID, name, MIME type, and other details.

For each file, the download_file_content function is responsible for downloading and extracting the content. The analyzer 116 supports different file types, including Google Docs, Google Sheets, PDFs, Excel files, Word documents, and presentations. Depending on the file type, the analyzer 116 either exports the content as plain text or extracts it using specialized parsers.

The analyzer 116 also includes helper functions such as process_sheet_data, which processes sheet data by identifying headers, normalizing column lengths, and converting data into a CSV format. For instance, all the rows should have the same number of columns, each row should have a header, each row should contain some headings and subheadings, and provide a detailed column description, if header is nor present in the rows.

In operation 206, a vector database 120 is generated that utilizes the analyzed one or more documents by converting the one or more parsed document content into vectorized embeddings using an embedding module 122. The conversion involves converting all contextual data in the documents in numerical format.

The vector database 120 generation involves converting the content of one or more analyzed documents into a numerical format that can be efficiently processed and stored for advanced queries and retrieval. A vector database 120 is a database that stores and manages vector embeddings, which are numerical representations of unstructured data like text, images, or audio. Vector databases 120 are useful for tasks like searching for similarity, finding relevant content, and retrieving items that best match a query. The vector data generated is stored in the vector database 120, for instance, Pinecone. Although not limited to Pinecone, there are various other databases to store the vector data, like, Chroma Qdrant, Weaviate, and so on.

The conversion of the text of the documents into vectorized embeddings is performed using the embedding module 122. Vectorized embeddings are numerical representations of the document content, capturing the contextual meaning, relationships, and key information contained within the text. This transformation allows the content to be stored in a vector database 120, where each document or segment of the document is represented as a vector, a multidimensional mathematical entity.

The conversion of the document content into vectors is achieved using machine learning algorithms. These algorithms analyze the textual data and extract important features such as terms, entities (like names, places, and dates), and the relationships between them. The analyzed document's text is broken down and encoded into vectors. These embeddings capture the content and context of the document in a numerical format, using strings to represent the relationships between words.

The embedding captures deeper connections between the words and concepts in the document, allowing for relationships to be encoded. For example, a document discussing climate change and global warming would have vectors representing both terms and their contextual relationship to each other. This encoding helps the embedding module 122 understand the meaning behind the content and allows for efficient information retrieval based on these relationships.

Once the content is converted into vectors and stored in the vector database 120, it enables highly efficient and accurate retrieval of information. By querying the vector database 120, the embedding module 122 can search for specific words, entities, or themes, and return relevant documents based on how closely their vector embeddings match the query.

An exemplary code used for embedding the analyzed documents in the document ingestion system 100 that manages documents and generates a summarized document using a user query is given below:

```
import logging
import cohere
import nltk
import os
import time
from typing import List, Dict
from pinecone_text.sparse import BM25Encoder
from app.core.config import settings
logger = logging.getLogger(“antenna.services.embedding”)
class EmbeddingService:
  def _{——}init_{——}(self):
    self.cohere_client = cohere.Client(settings.COHERE_API_KEY)
    self.bm25_encoder = BM25Encoder( ).default( )
    self._ensure_nltk_data( )
  def _ensure_nltk_data(self):
    nltk_data_dirs = [
```

| | |
|---|---|
| “/usr/local/share/nltk_data”, | # Docker image location |
| “/tmp/nltk_data”, | # Fallback location |

```
    ]
    for data_dir in nltk_data_dirs:
      nltk.data.path.append(data_dir)
    required_packages = [‘punkt’, ‘stopwords', ‘punkt_tab’]
    for package in required_packages:
      try:
        nltk.data.find(f“tokenizers/{package}”)
      except LookupError:
        logger.warning(f“NLTK data ‘{package}’ not found. Attempting
to download...”)
        try:
          self.download_with_retry(package)
        except Exception as e:
          logger.error(f“Failed to download NLTK data ‘{package}’:
{e}”)
          raise RuntimeError(f“Failed to ensure NLTK data
availability for ‘{package}’”)
    logger.info(“NLTK data ensured successfully”)
  def download_with_retry(self, package, max_retries=3, delay=5):
    for attempt in range(max_retries):
      try:
        nltk.download(package, quiet=True,
download_dir=“/tmp/nltk_data”)
        return
      except Exception as e:
        if attempt < max_retries − 1:
          logger.warning(f“Attempt {attempt + 1} failed. Retrying
in {delay} seconds...”)
          time.sleep(delay)
        else:
          raise e
  async def embed_chunks(self, chunks: List[str]) −> List[Dict[str,
List[float]]]:
    logger.info(f“Embedding {len(chunks)} chunks”)
    try:
      dense_vectors = await self._generate_dense_vectors(chunks)
      sparse_vectors = await self._generate_sparse_vectors(chunks)
      embeddings = [
        {
          “dense”: dense,
          “sparse”: sparse
        }
        for dense, sparse in zip(dense_vectors, sparse_vectors)
      ]
      logger.debug(f“Sample embedding: {embeddings[0] if embeddings
else ‘No embeddings generated’}”)
      return embeddings
    except Exception as e:
      logger.error(f“Error during embedding process: {e}”)
      raise
  async def _generate_dense_vectors(self, chunks: List[str]) −>
List[List[float]]:
    logger.info(f“Generating dense vectors for {len(chunks)} chunks”)
    try:
      response = self.cohere_client.embed(
        texts=chunks,
        model=“embed-english-v3.0”,
        input_type=“search_document”
      )
      return response.embeddings
    except Exception as e:
      logger.error(f“Error during dense embedding process: {e}”)
      raise
  async def _generate_sparse_vectors(self, chunks: List[str]) −>
List[List[float]]:
    logger.info(f“Generating sparse vectors for {len(chunks)} chunks”)
    try:
      self.bm25_encoder.fit(chunks)
      sparse_vectors = self.bm25_encoder.encode_documents(chunks)
      return sparse_vectors
    except Exception as e:
      logger.error(f“Error during sparse embedding process: {e}”)
      raise
embedding_service = EmbeddingService( )
```

The prompt given above includes an EmbeddingService function designed to generate both dense and sparse vector embeddings for text data, providing complete document processing, search, and retrieval tasks. This dual embedding allows the service to represent text in two forms, namely, dense embeddings that capture the deeper semantic meaning of the text, and sparse embeddings that emphasize term frequency and relevance within the text.

The main function, embed_chunks, takes a list of text chunks and processes them to create both dense and sparse vectors. The generate_dense_vectors function uses the Cohere API to convert the text into high-dimensional dense vectors, which capture the semantic relationships between words. Meanwhile, the generate_sparse_vectors function applies the encoding to produce sparse vectors that focus on keyword relevance and document ranking.

Further, the embedded documents are stored in the docker image location and the fallback location. The Docker image location refers to the default directory where the embedded data is stored when the application runs inside a Docker container. Docker is a platform used to package and deploy applications in isolated environments called containers, and this location ensures that embedded data is accessible within that container. The fallback location is an alternative directory where the application attempts to download and store embedded data if it isn't found in the primary Docker directory. This ensures that the necessary embedded data is available for natural language processing tasks even if the primary path fails or is unavailable.

In operation 208, a chunking module 124 chunks the embedded document content into smaller, coherent chunks based on semantic analysis, such as sections, paragraphs, or topics, to facilitate more granular processing and retrieval.

The chunking module 124 is responsible for dividing the embedded document content into smaller, meaningful sections, referred to as chunks. The chunking is supported by semantic analysis, which involves understanding the meaning and structure of the document to identify logical breakpoints, such as sections, paragraphs, or topics. By analyzing the content's context and flow, the chunking module 124 ensures that each chunk is generated keeping in view the context of the embedded data. This chunking enables more efficient processing, as smaller portions of text can be analyzed, stored, or retrieved independently, making information easier to manage. The chunking module 124 also enhances search and retrieval, allowing users to locate specific, relevant portions of documents based on more precise contextual or topical queries.

The document ingestion system 100 that manages documents and generates a summarized document using a user query utilizes Cohere tool to chunk the embedded data. Although the document ingestion system 100 that manages documents and generates a summarized document using a user query is not only limited to the use of the Coherent tool for chunking, other tools can also be used, like Bloom, Amazon Lex, Lyzr, and so on.

An exemplary code used for chunking the embedded documents in the document ingestion system 100 that manages documents and generates a summarized document using a user query is given below:

```
import logging
from typing import List
from semantic_chunkers import StatisticalChunker
from semantic_router.encoders import CohereEncoder
from llama_index.embeddings.cohere import CohereEmbedding
from llama_index.core.node_parser import SemanticSplitterNodeParser
from llama_index.core.schema import Document
from app.core.config import settings
logger = logging.getLogger(“antenna.services.chunking”)
class ChunkingService:
  def _{——}init_{——}(self):
    self.cohere_api_key = settings.COHERE_API_KEY
    self.embed_model = CohereEmbedding(
      api_key=self.cohere_api_key,
      model_name=“embed-english-v3.0”,
      input_type=“search_query”,
      embedding_type=“int8”
    )
    self.chunker = SemanticSplitterNodeParser(
      buffer_size=1,
      breakpoint_percentile_threshold=95,
      embed_model=self.embed_model
    )
  def chunk_content(self, content: str) −> List[str]:
    logger.info(f“Chunking content of length: {len(content)}”)
    try:
      doc = Document(text=content)
      nodes = self.chunker.get_nodes_from_documents([doc])
      return [node.text for node in nodes]
    except Exception as e:
      logger.error(f“Error during chunking process: {e}”)
      raise
chunking_service = ChunkingService( )
```

The code above defines a ChunkingService function that is responsible for breaking down large pieces of content into smaller, semantically coherent chunks. This is achieved through the integration of several components. First, the service initializes a CohereEmbedding model, which uses a specified API 134 to generate embeddings for the content. These embeddings play a crucial role in understanding the semantic relationships within the text. The SemanticSplitterNodeParser function is employed to perform the chunking, to identify logical breakpoints in the content based on a specified percentile threshold. This means that the service looks for significant shifts in meaning or topic, ensuring that the chunks are meaningful and relevant.

In operation 210, a ranking module 126 guides and constrains AI engine 130 to provide a rank to each chunked document by classifying the chunked documents into predefined categories, including, content, context, and semantic analysis, and prioritizing the classified one or more documents by generating a priority score for each document. The prioritization denotes the relevance and importance of the one or more documents.

The ranking module 126 assigns ranks to chunked documents based on various predefined criteria. The ranking module 126 categorizes these documents into predefined groups such as content, context, and semantic analysis, enabling a structured approach to evaluating their relevance and importance. Each chunked document is then assigned a priority score, which reflects its significance relative to other documents. This scoring is done based on several predefined criteria, including the reliability of the source, the importance of the content, and the freshness of the information. For instance, the document that is latest and includes reliable content is given a high priority score, rather than an older version of the document with less reliable content. Similarly, if the user has ingested an email that has a heading stating, ‘High priority mail’ or “Urgent’ Or ‘Important’, then the ranking module 126 will provide a high priority score to the email.

During the prioritization step, any document receiving a priority score below a threshold of 3 is disregarded, meaning it will not contribute to the knowledge graph generation. This thresholding is important for filtering out less relevant information.

The ranking module 126 further removes the documents with high-priority scores from the initial list of ingested documents. This step is followed by re-ranking the remaining documents using an artificial intelligence (AI) engine having a model, such as a large language model (LLM), which can analyze and evaluate content with greater depth and context. Finally, the re-ranked documents are combined with those that already have high priority scores, creating a refined and prioritized set of documents.

The ranking module 126 causes the prompt generator 128 to generate a prompt 129 with populated with exemplary data to guide and constrain the AI engine 130 to classify the chunked documents. An exemplary prompt 129 is given below:

You are an AI assistant specialized in classifying user requests into one of
the following tasks:
Current date and time: {date_today}
New App Generation
App Editing
Text Interaction
Product Acquisition Summary
Guidelines:
Read the user request carefully to determine whether they are asking to:
a) Generate/create/build a new App, UI, or Component
b) Edit/modify/update an existing App, UI, or Component
c) Ask a general question or request information
d) Requesting a comprehensive summary of a potential acquisition
If the user is explicitly asking for creating/building a new App, UI, or
Component, classify it as New App Generation.
If the user is explicitly asking to edit, modify, or update an existing App,
UI, or Component, or provides errors from their app, classify it as App
Editing.
If the user is not explicitly asking for creating/building or editing an App,
UI, or Component, choose Text Interaction.
For Product Acquisition Summary:
- Only classify as “acquisition” if the user explicitly requests a
comprehensive summary or overview of an acquisition.
- The request should include clear indicators like “summarize,” “give me an
overview,” or “provide a summary” in relation to an acquisition.
- Simply mentioning an acquisition or asking a specific question about an
acquisition does not qualify for this classification.
When in doubt, default to Text Interaction.
You must output a single word: “new_app” for New App Generation, “edit_app”
for App Editing, “text” for Text Interaction, or “acquisition” for Product
Acquisition Summary.
<example 1>
User Input: “I want to create a simple app that allows users to upload a file
and see a summary of the contents.”
Output: “new_app”
</example 1>
<example 2>
User Input: “I want to know the weather in New York.”
Output: “text”
</example 2>
<example 3>
User Input: “I need to process a csv and generate a report”
Output: “new_app”
</example 3>
<example 4>
User Input: “Can you add a download button to the app we just created?”
Output: “edit app”
</example 4>
<example 5>
User Input: “I'd like to modify the layout to make it more user-friendly and
maybe make it more colorful!”
Output: “edit_app”
</example 5>
<example 6>
User Input: “File “/home/user/app.py”, line 15
st.subheader(“Tasks”.)
\hat{ }
SyntaxError: invalid syntax”
Output: “edit_app”
</example 6>
<example 7>
User Input: “Provide a comprehensive summary of the Tivian acquisition.”
Output: “acquisition”
</example 7>
<example 8>
User Input: “What is the pre-acquisition 12 month revenue for Tivian?”
Output: “text”
</example 8>
<example 9>
User Input: “I heard about the Tivian acquisition. Can you tell me more about
it?”
Output: “text”
</example 9>
<example 10>
User Input: “Give me an overview of the recent acquisition, including key
financial metrics and strategic implications.”
Output: “acquisition”
</example 10>

An exemplary code to provide ranking to each chunked documents based on the multiple predefined criteria, in the document ingestion system 100 that manages documents and generates a summarized document using a user query is given below:

```
import logging
import cohere
from typing import List, Dict, Any
from pinecone import Pinecone
from pinecone_text.sparse import BM25Encoder
from app.core.config import settings
from app.models.pydantic_models import RetrieveRequest, RetrieveResponse,
RetrieveResult
from app.services.embedding_service import embedding_service
logger = logging.getLogger(“antenna.services.retrieve”)
class RetrieveService:
  def _{——}init_{——}(self):
    self.cohere_client = cohere.Client(settings.COHERE_API_KEY)
    self.pc = Pinecone(api_key=settings.PINECONE_API_KEY)
    self.index = self.pc.Index(settings.PINECONE_INDEX_NAME)
  async def perform_retrieval(self, request: RetrieveRequest) −>
RetrieveResponse:
    logger.info(f“Performing retrieval for query: {request.query}”)
    try:
      initial_top_k = request.top_k * 3 if settings.RERANK else
request.top_k
      query_vector = self._get_query_dense_embedding(request.query)
      query_sparse_vector =
self._get_query_sparse_embedding(request.query)
      search_results = self._perform_hybrid_search(
        namespace=request.namespace,
        query_vector=query_vector,
        query_sparse_vector=query_sparse_vector,
        top_k=initial_top_k
      )
      # Find the highest priority value
      max_priority = max((result[“metadata”].get(“priority”,
settings.DEFAULT_FILE_PRIORITY) for result in search_results),
default=settings.DEFAULT_FILE_PRIORITY)
      # Extract results with the highest priority
      priority_results = [result for result in search_results if
result[“metadata”].get(“priority”, settings.DEFAULT_FILE_PRIORITY) ==
max_priority]
      # Print file name, priority, and score for priority results
      for result in priority_results:
        file_name = result[“metadata”].get(“file name”, “Unknown”)
        priority = result[“metadata”].get(“priority”,
settings.DEFAULT_FILE_PRIORITY)
        score = result[“score”]
        logger.info(f“Priority Result - File: {file_name}, Priority:
{priority}, Score: {score}”)
      if settings.RERANK:
        # Remove highest priority results from search_results
        search_results = [result for result in search_results if
result[“metadata”].get(“priority”, settings.DEFAULT_FILE_PRIORITY) <
max_priority]
        if not search_results:
          logger.info(“No documents left for reranking after
priority filtering. Skipping rerank.”)
          reranked_results = [ ]
        else:
          # Adjust the number of documents to rerank
          docs = [result[“metadata”].get(“text”, “”) for result in
search_results]
          # Perform reranking using Cohere
          rerank_results = self.cohere_client.rerank(
            query=request.query,
            documents=docs,
            top_n=request.top_k,
            model=“rerank-english-v3.0”
          )
          # Combine reranked results with original metadata
          reranked_results = [ ]
          # Filter reranked results based on RERANK_THRESHOLD
          filtered_reranked_results = [
            result for result in rerank_results.results
            if result.relevance_score > settings.RERANK_THRESHOLD
          ]
          for rerank_item in filtered_reranked_results:
            original_result = search_results[rerank_item.index]
            reranked_results.append({
              “id”: original_result[“id”],
              “score”: original_result[“score”],
              “rerank_score”: rerank_item.relevance_score,
              “metadata”: original_result[“metadata”]
            })
          # Print file name, priority, and score for priority
results
          for result in reranked_results:
            file_name = result[“metadata”].get(“file_name”,
“Unknown”)
            priority = result[“metadata”].get(“priority”,
settings.DEFAULT_FILE_PRIORITY)
            score = result[“score”]
            rerank_score = result[“rerank_score”]
            logger.info(f“Reanked Result - File: {file_name},
Priority: {priority}, Score: {score}, Rerank Score: {rerank_score}”)
      final_results = [ ]
      if settings.RERANK:
        # Combine priority_results with reranked_results
        final_results = priority_results +
reranked_results[:request.top_k]
      else:
        final_results = priority_results
      if len(final_results) > 0:
        # Sort the combined results by priority in descending order
        logger.info(f“Final results before sorting: {final_results}”)
        final_results.sort(key=lambda x: x[“metadata”][“priority”],
reverse=True)
      # Print file name, priority, and score for priority results
      for result in final_results:
        file_name = result[“metadata”].get(“file_name”, “Unknown”)
        priority = result[“metadata”].get(“priority”,
settings.DEFAULT_FILE_PRIORITY)
        score = result[“score”]
        rerank_score = result[“rerank_score”] if “rerank_score” in
result else None
        logger.info(f“Final Result - File: {file_name}, Priority:
{priority}, Score: {score}, Rerank Score: {rerank_score}”)
      filtered_final_results = [
        result for result in final_results
        if result[“score”] >= settings.SCORE_THRESHOLD
      ]
      retrieve_results = [
        RetrieveResult(id=result[“id”],
text=result[“metadata”].get(“text”, “”), score=result[“score”],
file_name=result[“metadata”].get(“file_name”, “”),
mime_type=result[“metadata”].get(“mime_type”, “”),
web_view_link=result[“metadata”].get(“web_view_link”, “”),
priority=result[“metadata”].get(“priority”),
sheet_name=result[“metadata”].get(“sheet_name”, “”))
        for result in filtered_final_results
      ]
      return RetrieveResponse(
        query=request.query,
        results=retrieve_results
      )
    except Exception as e:
      logger.error(f“Error during retrieval: {str(e)}”, exc_info=True)
      raise
  def _get_query_dense_embedding(self, query: str) −> List[float]:
    “““Generate an embedding for the given query using the Cohere API.”””
    response = self.cohere_client.embed(
      texts=[query],
      model=“embed-english-v3.0”,
      input_type=“search_query”
    )
    logger.info(f“\n\n\n\n\nQuery embedding:
{response.embeddings[0]}\n\n\n\n\n”)
    return response.embeddings[0]
  def _get_query_sparse_embedding(self, query: str) −> List[float]:
    “““Generate a sparse embedding for the given query using the Cohere
API.”””
    bm25 = embedding_service.bm25_encoder
    return bm25.encode_queries(query)
  def _perform_hybrid_search(self, namespace: str, query_vector:
List[float], query_sparse_vector: List[float], top_k: int) −> List[Dict[str,
Any]]:
    “““Perform a hybrid search using the Pinecone index.”””
    query_results = self.index.query(
      namespace=namespace,
      vector=query_vector,
      sparse_vector=query_sparse_vector,
      top_k=top_k,
      include_values=True,
      include_metadata=True
    )
    return [
      {
        “id”: match.id,
        “score”: match.score,
        “metadata”: match.metadata
      }
      for match in query_results.matches
    ]
retrieve_service = RetrieveService( )
```

The RetrieveService function is designed to facilitate efficient document retrieval through a hybrid approach that utilizes both dense and sparse embeddings. It begins by initializing connections to the Cohere API for embedding generation and the Pinecone API for managing the document index. When a retrieval request is made, the service first generates dense and sparse embeddings for the user's query. The dense embeddings are obtained through the Cohere API, which transforms the query into a vector representation, while the sparse embeddings are created using an encoder, which is part of the embedding.

Once the embeddings are generated, the service conducts a hybrid search using these vectors against a Pinecone index. This search retrieves the most relevant documents based on the query's embeddings. The results are further refined by evaluating the priority of each document based on metadata tags, allowing the function to extract only those documents with the highest priority scores. If enabled, a reranking process is applied to refine the results further by utilizing the additional context and relevance scoring from Cohere. This reranking uses the original search results, removing high-priority entries and adjusting the ranking of remaining documents based on relevance.

The function then combines the top-priority documents with the reranked results, sorting them based on their priority scores to ensure the most important documents are presented first. Each document's details, including file names, priorities, and scores, are logged for transparency. Ultimately, the final set of results is filtered to meet a specified score threshold before being packaged into a structured response format. Finally, the documents with high priority are displayed in the vector database 120, mentioning the filename, and priority score.

The document ingestion system 100 manages documents and generates a summarized document using a user query, automatically generates a knowledge graph related to prioritized documents, and involves creating a visual and data-driven representation that displays the relationships, relevance, and interconnectivity between those documents. The knowledge graph is essentially a network where the documents and the key concepts or entities extracted from them are represented as nodes, and the relationships between them are depicted as edges or connections. This structured representation of the knowledge graph enhances the understanding of how different documents are linked based on shared concepts, themes, or topics.

The development of the knowledge graph is achieved by utilizing advanced techniques, such as Natural Language Processing (NLP), to analyze the content of the documents and identify important entities (such as people, places, dates, or keywords) and the relationships between them. For example, suppose multiple documents discuss a specific topic or mention the same entities. In that case, the knowledge graph will create nodes for these entities and draw edges between them, illustrating how the documents are interconnected. This linkage helps to create a more organized and coherent view of the documents' content, enabling users to navigate through related documents more efficiently and understand their contextual relevance. For instance, suppose a user has provided a query to the online document management platform 102, regarding the generation of an application that indicates ant behavior simulation, based on the ingested documents. Based on this a knowledge graph is generated which shows the behavior of the ants, i.e., how they move when they are provided food.

The knowledge graph is dynamic, i.e., it continuously evolves as new documents are ingested into the data ingestor 114 or when existing documents are updated. Whenever new documents are added, the analyzer 116 automatically scans the content to identify any new entities or relationships and updates the graph accordingly.

In operation 212, a prompt generator 128 generates a prompt 129 to guide the AI engine 130 to process the prioritized documents to generate the summarized document or answer the user query. The user query is provided by the user in the form of a natural language input that is easy to understand by the AI engine 130.

Before the prompt generation, a prompt engineer provides a prompt structure along with a set of guidelines and some examples, to guide and constrain the AI engine 130 to generate the summarized documents. By utilizing the prioritized documents which are provided a high priority score using the ranking module 126, the prompt generator 128 generates the prompt 129. The prompt generator 128 utilizes the documents with a high priority score and populates the prompt structure provided by the prompt engineer.

The prompt generator 128 utilizes NLP (Natural Language Processing) techniques to populate the prompt provided by the prompt engineer based on the high-priority documents ranked by the ranking module 126.

An exemplary prompt structure provided to the prompt generator 128 by the prompt engineer to guide the AI engine 130 to process the user request is given below:

```
dynamic_task_prompt_system = “““
You are Anne Bonny, an AI assistant specialized at creating structured task
plans out of user requests, using a defined set of subtask types to choose
from. Your output should be a JSON array of subtasks, each with a specific
type, ID, query, and (where applicable) dependencies.
Available subtask types:
RETRIEVE: Used to gather additional context from a Private Vector Store.
GENERATE_TEXT: Used to generate a text-based response.
GENERATE_CODE: Used to generate a React App.
AGGREGATE: Used to combine text outputs from two different steps for use in a
later step.
Subtask Rules:
- AGGREGATE tasks must have dependencies on the tasks that are used to create
the aggregate, which are usually two RETRIEVE tasks.
- GENERATE_CODE tasks must have a dependency on the GENERATE_TEXT task that
is used to create the code.
Instructions:
1. Analyze the user's request and break it down into necessary subtasks.
2. For each subtask, determine the appropriate type from the available
options.
3. Assign a unique ID to each subtask, following the format:
<type_lowercase>_<number> (e.g., retrieve_1, generate_text_2).
4. Provide a relevant query for each subtask, except for AGGREGATE tasks
where the query can be empty.
5. Determine dependencies between tasks and list them where applicable.
6. Output the result as a JSON array of objects, each representing a subtask.
Output Format:
[
  {
    “type”: “TASK_TYPE”,
    “id”: “task_id”,
    “query”: “task_query”,
    “dependencies”: [“dependent_task_id_1”, “dependent_task_id_2”]
  },
  ...
]
Note: The “dependencies” field should only be included if the task has
dependencies.
Example:
User Request: “Compare the characteristics of cyborgs and centaurs.”
Output:
jsonCopy [
  {“type”: “RETRIEVE”, “id”: “retrieve_1”, “query”: “What is a Cyborg?”},
  {“type”: “RETRIEVE”, “id”: “retrieve_2”, “query”: “What is a Centaur?”},
  {“type”: “AGGREGATE”, “id”: “aggregate_1”, “dependencies”: [“retrieve_1”,
“retrieve_2”]},
  {“type”: “GENERATE_TEXT”, “id”: “generate_text_1”, “query”: “Compare the
characteristics of cyborgs and centaurs”, “dependencies”: [“aggregate_1”]}
]
Now, please process the following user request and generate an appropriate
task plan:
[USER_REQUEST]
```

In operation 214, the prompt generator 128 transfers the generated prompt 129 to the AI engine 130 to pre-process the prioritized documents to generate application codes and the summarized document, as queried by the user.

The prompt generator 128 generates the prompt 129 that guide the AI engine 130 to generate the summarized document or anything that is queried by the user. When a user submits a query, the prompt generator 128 generates prompt 129 in correspondence to the content of the prioritized documents, which have already been identified as relevant through previous processing steps. These prompts not only guide the AI engine 130 on what information to focus on but also help structure the output according to the user's needs, whether that be summarized content or executable application code. For instance, if a user needs a summary of the financial status of the organization based on around 100 documents ingested. Then the AI engine 130 will generate a summary of the financial status of the organization by utilizing the priority documents by utilizing the guidelines, and the examples provided in the prompt 129 generated by the prompt generator 128.

The AI engine 130 along with showing the summarized document or anything that is queried by the user also displays an application code. It begins with the AI engine 130 analyzing the prioritized documents to identify key concepts, logic, and patterns relevant to the user's request. Based on this analysis, the AI engine 130 constructs executable application code snippets that can be directly implemented in a programming environment.

Furthermore, the application code generated incorporates multiple programming frameworks and languages, such as React for building dynamic web applications and Streamlit for creating interactive data applications. Each code snippet produced by the AI engine 130 is accompanied by detailed explanations that clarify the functionality of the code.

The generation of the applications based on the user query and the use of the application codes, like React Code, and Streamlit code is explained in detail in U.S. Provisional Patent Application No. 63/714,907, which is incorporated herein be reference in its entirety.

An exemplary prompt 129 provided by the prompt generator 128 to the AI engine 130 is given below:

```
dynamic_task_prompt_system = “““
You are Anne Bonny, an AI assistant specialized at creating structured task
plans out of user requests, using a defined set of subtask types to choose
from. Your output should be a JSON array of subtasks, each with a specific
type, ID, query, and (where applicable) dependencies.
Available subtask types:
RETRIEVE: Used to gather additional context from a Private Vector Store.
GENERATE_TEXT: Used to generate a text-based response.
GENERATE_CODE: Used to generate a React App.
AGGREGATE: Used to combine text outputs from two different steps for use in a
later step.
Subtask Rules:
- AGGREGATE tasks must have dependencies on the tasks that are used to create
the aggregate, which are usually two RETRIEVE tasks.
- GENERATE_CODE tasks must have a dependency on the GENERATE_TEXT task that
is used to create the code.
Instructions:
1. Analyze the user's request and break it down into necessary subtasks.
2. For each subtask, determine the appropriate type from the available
options.
3. Assign a unique ID to each subtask, following the format:
<type_lowercase>_<number> (e.g., retrieve_1, generate_text_2).
4. Provide a relevant query for each subtask, except for AGGREGATE tasks
where the query can be empty.
5. Determine dependencies between tasks and list them where applicable.
6. Output the result as a JSON array of objects, each representing a subtask.
Output Format:
[
  {
    “type”: “TASK_TYPE”,
    “id”: “task_id”,
    “query”: “task_query”,
    “dependencies”: [“dependent_task_id_1”, “dependent_task_id_2”]
  },
  ...
]
Note: The “dependencies” field should only be included if the task has
dependencies.
Example:
User Request: “Compare the characteristics of cyborgs and centaurs.”
Output:
jsonCopy[
  {“type”: “RETRIEVE”, “id”: “retrieve_1”, “query”: “What is a Cyborg?”},
  {“type”: “RETRIEVE”, “id”: “retrieve_2”, “query”: “What is a Centaur?”},
  {“type”: “AGGREGATE”, “id”: “aggregate_1”, “dependencies”: [“retrieve_1”,
“retrieve_2”]},
  {“type”: “GENERATE_TEXT”, “id”: “generate_text_1”, “query”: “Compare the
characteristics of cyborgs and centaurs”, “dependencies”: [“aggregate_1”]}
]
Now, please process the following user request and generate an appropriate
task plan:
[{
  “namespace”: “drive_1ya3gwhzbo-eiit6sykkxulmaey-ufkid”,
  “query”: “What is required for R&D expenses to qualify for the Section 41 tax credit?”,
  “top_k”: 5
}
]
```

In operation 216, a document generator 132 generates the summarized document at various fidelity levels for the ingested documents to create an adaptive mechanism that can use document prioritization. The summary provides a concise answer to the user queries, with varying levels of detail depending on the depth of the information required.

The document generator 132 transforms ingested documents into summarized formats that fulfill varying user needs, thereby creating an adaptive mechanism that utilizes document prioritization effectively. The document generator 132 synthesizes the original content into concise summaries at multiple fidelity levels, enabling users to choose the depth of information they require based on their specific queries. The fidelity levels range from a full raw context summary, which preserves the entire original detail for comprehensive understanding, to a detailed summary that captures essential points while omitting non-relevant information.

This approach ensures that users can easily access the information most relevant to their needs, whether they are seeking an in-depth exploration of a topic or quick insights. For instance, if a user has ingested a folder with 5 documents and needs a summary based on the list of all documents, then the document generator 132 will create a summary of all the documents. The user doesn't have to go through all the documents to create a summary, and the commands provided by the user are also user-friendly. The user doesn't have to write complex programming codes to do all this. The document generator 132 automatically performs actions based on the user query.

The response generated by the document generator 132 for the prompt provided by the user querying the online document management platform 102 with a question, stating, ‘What is required for R&D expenses to qualify for the Section 41 tax credit?’ is given below:

```
{
  “message”: “Success”,
  “result”: {
    “query”: “What is required for R&D expenses to qualify for the
Section 41 tax credit?”,
    “namespace”: “drive_1ya3gwhzbo-eiit6sykkxulmaey-ufkid”,
    “top_k”: 5,
    “results”: [
      {
        “id”: “Finance 2nd Brain: Tax Strategy_36”,
        “score”: 0.815217,
        “metadata”: {
          “file_name”: “Finance 2nd Brain: Tax Strategy”,
          “text”: “* For R&D expenses to qualify for the Section 41
tax credit, research must be conducted within the U.S. or its territories. It
is not enough that the IP is owned by a US company. * The Section 41 credit
applies only to R&D activities conducted before the product reaches
commercial production. Adaptation or replication of existing technology does
not qualify. * Because Section 41 references Section 174, the recent
classification of all software development as R&D might provide a textual
basis for expanded credit eligibility. However, this interpretation is not
adopted by the government or practitioners. * Tax credit provisions are
generally interpreted narrowly against the taxpayer, ensuring application
only in clearly intended situations. * Under current law, software
development costs qualifying for the Section 41 credit are a subset of those
that must be capitalized under Section 174. Mandatory capitalization may end
if Congress amends the law.”
        }
      }
    ...]
  }
}
```

An exemplary code to generate the summary of the ingested documents or answers to the user queries by utilizing the ingested documents in the document ingestion system 100 manages documents and generate a summarized document using a user query is given below:

The pseudo-code used in the document ingestion system 100 that manage documents and generates a summarized document using a user query is given below:

```
function parseText(document):
  return extracted_text
function assignMetadata(text):
  metadata = analyzeText(text)
  return metadata
function constructGraph(data_points):
  graph = new Graph( )
  for data in data_points:
  graph.addNode(data)
    for related_data in findRelations(data):
      graph.addEdge(data, related_data)
  return graph
function summarizeDocument(text, level_of_detail):
  summary = generateSummary(text, level_of_detail)
  return summary
```

In an embodiment, a link of the cloud storage 110, for instance, Google Drive, in the case of the present example is provided to the data ingester 134 vi., the API bundle 134 to index the ingested data. The function URL includes: https://ijenyptuyjq4kg5omiug5pnxri0ftugu.lambda-url.us-east-1.on.aws/

The input, i.e., the link of the cloud storage 110 provided by the user is given below:

{
‘drive_url’: ‘https://drive.google.com/drive/u/0/folders/1Ya3gWhZbO-
EIIT6SykkxuLMaEY-ufkiD’
}

The output generated based on the input provided by the user includes:

{‘statusCode’: 200, ‘body’: ‘{“manifest”: [{“mimeType”:
“application/vnd.google-apps.document”, “webViewLink”:
“https://docs.google.com/document/d/1vEANATZ38SIsuKtBus4TucpZLBLyVJw6ftm4X2hi
lqo/edit?usp=drivesdk”, “id”: “1vEANATZ38SIsuKtBus4TucpZLBLyVJw6ftm4X2hilqo”,
“name”: “Central Support - 2nd Brain NEW”}...], \\\“index_reference\\\”:
\\\“drive_1ya3gwhzbo-eiit6sykkulmaey-ufkid\\\”}\“}}”}

The output generated helps in indexing the data of the documents ingested by the user. Data indexing is the process of organizing data in a way that makes it faster and more efficient to retrieve specific information from a database or large dataset. Indexes significantly enhance query performance by quickly locating the search results.

In another embodiment, a link of the cloud storage 110, for instance, Google Drive, in the case of the present example is provided to the data ingester 134 vi., the API bundle 134 to retrieve a response to the user query. The function URL includes: https://n5yszahunmorzlelud4phzdg3i0wxphb.lambda-url.us-east-1.on.aws/

The input, i.e., the link of the cloud storage 110 provided by the user is given below:

```
{
  “namespace”: “drive_1ya3gwhzbo-eiit6sykkxulmaey-ufkid”,
  “query”: “What is required for R&D expenses to qualify for the Section
41 tax credit?”,
  “top_k”: 5
}
```

The output generated based on the input provided by the user includes:

```
{
  “message”: “Success”,
  “result”: {
    “query”: “What is required for R&D expenses to qualify for the
Section 41 tax credit?”,
    “namespace”: “drive_1ya3gwhzbo-eiit6sykkxulmaey-ufkid”,
    “top_k”: 5,
    “results”: [
      {
        “id”: “Finance 2nd Brain: Tax Strategy_36”,
        “score”: 0.815217,
        “metadata”: {
          “file_name”: “Finance 2nd Brain: Tax Strategy”,
          “text”: “* For R&D expenses to qualify for the Section 41
tax credit, research must be conducted within the U.S. or its territories. It
is not enough that the IP is owned by a US company. * The Section 41 credit
applies only to R&D activities conducted before the product reaches
commercial production. Adaptation or replication of existing technology does
not qualify. * Because Section 41 references Section 174, the recent
classification of all software development as R&D might provide a textual
basis for expanded credit eligibility. However, this interpretation is not
adopted by the government or practitioners. * Tax credit provisions are
generally interpreted narrowly against the taxpayer, ensuring application
only in clearly intended situations. * Under current law, software
development costs qualifying for the Section 41 credit are a subset of those
that must be capitalized under Section 174. Mandatory capitalization may end
if Congress amends the law.”
        }
      }
    ...]
  }
}
```

The output generated explains the answer to the query asked by the user, i.e., ‘What is required for R&D expenses to qualify for the Section 41 tax credit?’, based on the documents provided by the user. The ‘namespace’ suggests the name of the folder ingested by the user.

In another embodiment, a link of the cloud storage 110, for instance, Google Drive, in the case of the present example is provided to the data ingester 134 vi., the API bundle 134 to retrieve a response to the user query. The function URL includes: https://vlq3xj5ppiykcsacw4wij5rlci0qfkom.lambda-url.us-east-1.on.aws/

The input, i.e., the link of the cloud storage 110 provided by the user is given below:

```
{
  “namespace”: “drive_1ya3gwhzbo-eiit6sykkxulmaey-ufkid”,
  “query”: “What is required for R&D expenses to qualify for the Section
41 tax credit?”
}
```

The output generated based on the input provided by the user includes:

```
{
  ″message″: ″Success″,
  ″result″: {
    ″sources″: [
      {
        ″file_name″: ″Central Support - 2nd Brain NEW″
        ″url″:
″https://docs.google.com/document/d/1vEANATZ38SIsuKtBus4TucpZLBLyVJw6ftm4X2hi
lqo/edit?usp=drivesdk″,
        ″mime_type″: ″application/vnd.google-apps.document″
      }
    ],
    ″response″: ″<text>\nThe note-taking app I'm about to generate will allow
users to create, edit, and save notes. The app will have a simple and
intuitive interface, making it easy for users to organize their thoughts and
ideas.\n\nHere's an overview of how the app will work:\n\n* Users can create
new notes by clicking on the \″New Note\″ button.\n* Each note will have a
title and a content area where users can type in their notes.\n* Users can
save their notes by clicking on the \″Save\″ button.\n* The app will display
a list of all saved notes, allowing users to easily access and edit their
previous notes.\n\nTo implement this app, I'll use React and Tailwind CSS for
styling. I'll create a ‘Note‘ component that will handle the creation,
editing, and saving of notes. The component will use React state to store the
note title and content.\n\nHere's an example of how the ‘Note‘ component
might look:\n‘‘‘jsx\nfunction Note( ) {\n const [title, setTitle] =
useState(′′);\n const [content, setContent] = useState(′′);\n\n const
handleSubmit = ( ) => {\n // Save the note to local storage or a database\n
};\n\n return (\n <div>\n <input\n type=\″text\″\n
value={title}\n onChange={(e) => setTitle(e.target.value)}\n
placeholder=\ ″Note title\″\n />\n <textarea\n
value={content}\n onChange={(e) => setContent(e.target.value)}\n
placeholder=\″Note content\″\n />\n <button
onClick={handleSubmit}>Save</button>\n </div>\n
);\n}\n‘‘‘\n</text>\n\<artifact>\n‘‘‘jsx\nimport React, { useState } from
′react′;\n\nfunction Note( ) {\n const [title, setTitle] = useState(′′);\n
const [content, setContent] = useState(′′);\n const [notes, setNotes] =
useState([ ]);\n\n const handleSubmit = ( ) => {\n const newNote = { title,
content };\n setNotes([...notes, newNote]);\n setTitle(′′);\n
setContent(′′);\n };\n\n const handleEdit = (index) => {\n const note =
notes[index];\n setTitle(note.title);\n setContent(note.content);\n
};\n\n const handleDelete = (index) => {\n setNotes(notes.filter((_, i)
=> i !== index));\n };\n\n return (\n <div className=\″flex flex-col h-
screen p-4\″>\n <h1 className=\″text-2xl\″>Note Taking App</h1>\n
<form onSubmit={(e) => e.preventDefault( )}>\n <input\n
type=\″text\″\n value={title}\n onChange={(e) =>
setTitle(e.target.value)}\n placeholder=\″Note title\″\n
className=\″w-full p-2 mb-2\″\n />\n <textarea\n
value={content}\n onChange={(e) => setContent(e.target.value)}\n
placeholder=\″Note content\″\n className=\″w-full p-2 mb-2\″\n
/>\n <button onClick={handleSubmit} className=\″bg-blue-500 hover:bg-
blue-700 text-white font-bold py-2 px-4 rounded\″>\n Save\n
</button>\n </form>\n <ul className=\″list-none p-0 m-0\″>\n
{notes.map((note, index) => (\n <li key={index} className=\″mb-
2\″>\n <h2>{note.title}</h2>\n <p>{note.content}</p>\n
<button onClick={( ) => handleEdit(index)} className=\″bg-yellow-500 hover:bg-
yellow-700 text-white font-bold py-2 px-4 rounded\″>\n Edit\n
</button>\n <button onClick={( ) => handleDelete(index)}
className=\″bg-red-500 hover:bg-red-700 text-white font-bold py-2 px-4
rounded\″>\n Delete\n </button>\n </li>\n
))}\n </ul>\n </div>\n );\n}\n\nexport default
Note;\n‘‘‘\</artifact>″
  }
}
```

The output explains the details of an application generated by the AI engine 130, along with the application code that is used to create the application. The user can input a query on the application generated and get the response.

In an embodiment, the document ingestion system 100 can utilize the shortcuts given below to perform the corresponding task:

/account
# Existing endpoints

| | | |
|---|---|---|
| POST | /account/login | - User login |
| POST | /account/logout | - User logout |
| GET | /account/profile | - Get user profile |
| PUT | /account/profile | - Update user profile |
| POST | /account/register | - Register new user |
| POST | /account/verify | - Verify user account |
| POST | /account/reset-password | - Reset password |

# Global Account Preferences

| | | |
|---|---|---|
| GET | /account/preferences/global | - Get all global |

preferences

| | | |
|---|---|---|
| PUT | /account/preferences/global | - Update all global |

preferences

| | | |
|---|---|---|
| GET | /account/preferences/global/{pref_key} | - Get specific global |

preference

| | | |
|---|---|---|
| PUT | /account/preferences/global/{pref_key} | - Update specific |

global preference
# User-specific Preferences

| | | |
|---|---|---|
| GET | /account/preferences/{user_id} | - Get all user-specific |

preferences

| | | |
|---|---|---|
| PUT | /account/preferences/{user_id} | - Update all user- |

specific preferences

| | | |
|---|---|---|
| GET | /account/preferences/{user_id}/{pref_key} | - Get specific user |

preference

| | | |
|---|---|---|
| PUT | /account/preferences/{user_id}/{pref_key} | - Update specific user |

preference
# LM Model Preferences

| | | |
|---|---|---|
| GET | /account/preferences/lm-model | - Get all LM model |

preferences

| PUT | /account/preferences/lm-model | - Update all LM model |
|---|---|---|
| preferences | | |
| GET | /account/preferences/lm-model/{model_key} | - Get specific LM model |

preference

| | | |
|---|---|---|
| PUT | /account/preferences/lm-model/{model_key} | - Update specific LM |

model preference
# External service connectors

| | | |
|---|---|---|
| GET | /account/connectors | - List all connected services |
| POST | /account/connectors | - Add a new service connector |
| GET | /account/connectors/{service} | - Get details of a specific connector |
| PUT | /account/connectors/{service} | - Update a specific connector |
| DELETE | /account/connectors/{service} | - Remove a specific connector |

# OAuth flow for external services?

| | | |
|---|---|---|
| GET | /account/connectors/{service}/auth | - Initiate OAuth flow |
| GET | /account/connectors/{service}/callback | - OAuth callback URL |

# Sharing connectors between users?

| | | |
|---|---|---|
| POST | /account/connectors/{service}/share | - Share a connector with |

another user

| | | |
|---|---|---|
| GET | /account/connectors/shared | - List shared connectors |
| POST | /account/connectors/shared/{id}/accept | - Accept a shared connector |
| POST | /account/connectors/shared/{id}/reject | - Reject a shared connector |

Library
/library
# Document Management

| | | |
|---|---|---|
| GET | /library/documents | - List all documents (with |

filtering options)

| | | |
|---|---|---|
| POST | /library/documents | - Add a new document manually |
| GET | /library/documents/{document_id} | - Get a specific document |
| PUT | /library/documents/{document_id} | - Update a document |
| DELETE | /library/documents/{document_id} | - Delete a document |

# Search

| | | |
|---|---|---|
| POST | /library/search | - Search documents (text, |

tags, priority, etc.)
# Priority and Rating

| | | |
|---|---|---|
| GET | /library/documents/{document_id}/priority | - Get document |

priority

| | | |
|---|---|---|
| POST | /library/documents/{document_id}/priority | - Set priority |

(admin/owner only)

| | | |
|---|---|---|
| POST | /library/documents/{document_id}/vote/up | - Upvote a |

document

| | | |
|---|---|---|
| POST | /library/documents/{document_id}/vote/down | - Downvote a |

document

| | | |
|---|---|---|
| DELETE | /library/documents/{document_id}/vote | - Remove user's |

vote

| | | |
|---|---|---|
| GET | /library/documents/trending | - Get trending |

documents based on recent votes
# Tags

| | | |
|---|---|---|
| GET | /library/tags | - List all tags |
| POST | /library/tags | - Create a new tag |
| DELETE | /library/tags/{tag_id} | - Delete a tag |
| PUT | /library/documents/{document_id}/tags | - Update tags for a document |

# Statistics

| | | |
|---|---|---|
| GET | /library/stats | - Get library statistics |

Ingest
/library/ingest

| | | |
|---|---|---|
| POST | /library/ingest | - Start ingestion process |

(main endpoint)

| | | |
|---|---|---|
| GET | /library/ingest/status/{job_id} | - Get ingestion job status |
| POST | /library/ingest/cancel/{job_id} | - Cancel ingestion job |

# Target-specific ingestion and strategies

| | | |
|---|---|---|
| GET | /library/ingest/targets | - List available ingestion |

targets

| | |
|---|---|
| GET | /library/ingest/targets/{target}/strategies - List strategies for a |

specific target
# Configuration

| | | |
|---|---|---|
| GET | /library/ingest/config | - Get current ingestion |

configuration

| | | |
|---|---|---|
| PUT | /library/ingest/config | - Update ingestion |

configuration
# Source-specific ingestion (optional, for direct source ingestion)

| | | |
|---|---|---|
| POST | /library/ingest/sources/gdrive | - Ingest from Google Drive |
| POST | /library/ingest/sources/onedrive | - Ingest from OneDrive |
| POST | /library/ingest/sources/s3 | - Ingest from AWS S3 |

Retrieve
/library/retrieve

| | | |
|---|---|---|
| POST | /library/retrieve | - Combined multi-functional |

search

| | | |
|---|---|---|
| GET | /library/retrieve/config | - Get retrieval configuration |
| PUT | /library/retrieve/config | - Update retrieval |

configuration
# Target-specific retrieval

| | | |
|---|---|---|
| POST | /library/retrieve/vector | - Query vector database |
| POST | /library/retrieve/graph | - Query graph database |

# Document retrieval

| | | |
|---|---|---|
| GET | /library/retrieve/document/{doc_id} | - Retrieve a specific document |

# Retrieval strategies

| | | |
|---|---|---|
| GET | /library/retrieve/strategies | - List available retrieval |

strategies
Interact
/interact

| | | |
|---|---|---|
| POST | /interact | - Main interaction endpoint |

(default)

| | | |
|---|---|---|
| GET | /interact/history | - Get interaction history |

/chat

| | | |
|---|---|---|
| POST | /interact/chat/start | - Start a new chat session |
| POST | /interact/chat/{session_id} | - Continue an existing chat |

session

| | | |
|---|---|---|
| GET | /interact/chat/{session_id} | - Retrieve a chat session |
| DELETE | /interact/chat/{session_id} | - End and delete a chat |

session
/tasks

| | | |
|---|---|---|
| POST | /interact/tasks/execute | - Execute a task |
| GET | /interact/tasks | - List all tasks (with |

filtering options)

| | | |
|---|---|---|
| GET | /interact/tasks/{job_id} | - Get details of a specific |

task

| | | |
|---|---|---|
| POST | /interact/tasks/{job_id}/cancel | - Cancel a running task |
| POST | /interact/tasks/{job_id}/pause | - Pause the task |
| POST | /interact/tasks/{job_id}/resume | - Resume the task |

/research

| | | |
|---|---|---|
| POST | /interact/tasks/research | - Start a research task |
| GET | /interact/tasks/research/{job_id} | - Get research results |

/artifacts

| | | |
|---|---|---|
| POST | /interact/tasks/artifacts | - Generate an artifact |

(e.g., code)

| | | |
|---|---|---|
| GET | /interact/tasks/artifacts/{artifact_id} | - Retrieve a generated |

artifact

| | | |
|---|---|---|
| GET | /interact/tasks/artifacts/templates | - Retrieve available |

templates

| | | |
|---|---|---|
| POST | /interact/tasks/artifacts/generate | - Generate artifact |

code by template

| | | |
|---|---|---|
| POST | /interact/tasks/artifacts/sandbox | - Get/Create Sandbox |

given template
/text

| | | |
|---|---|---|
| POST | /interact/tasks/text | - Perform a text-based |

task (including queries, summarization, translation, etc.)

| | | |
|---|---|---|
| GET | /interact/config | - Get interaction |

configuration (proxy to account preferences)

| | | |
|---|---|---|
| PUT | /interact/config | - Update interaction |

configuration (proxy to account preferences)

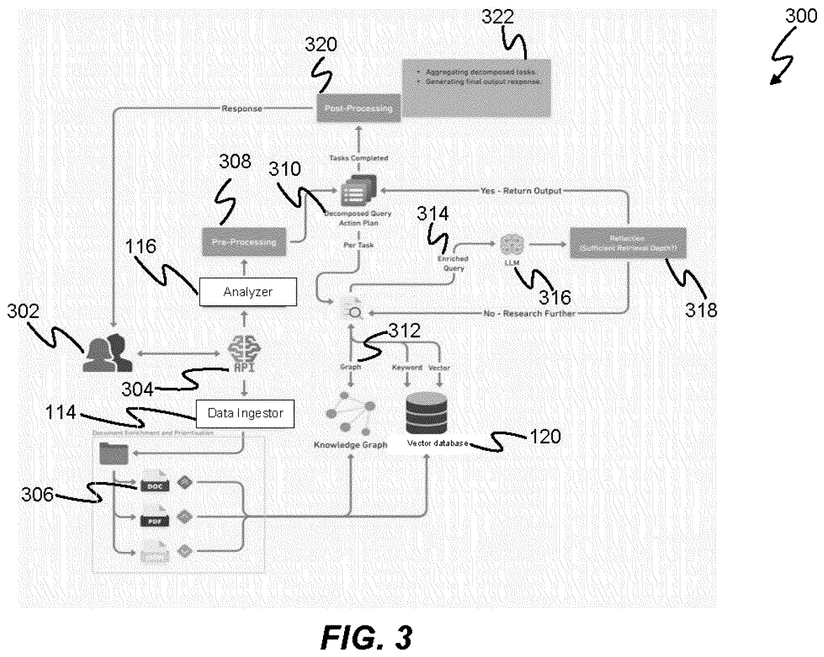

FIG. 3 depicts an exemplary ingested documents processing system 300, which is an embodiment of the document ingestion system 100 that manages documents and generates a summarized document using a user query of FIG. 1.

The ingested documents processing system 300 includes a user 302 that uploads documents 306 from either local storage 108 or cloud storage 110 to the online document management platform 102. These documents 306 could be in a variety of formats, including PDFs, Word files, emails, or others. Once uploaded, the ingested documents processing system 300 the documents 306 to the data ingestor 114. This is done via API bundles 304, where a link to the folder containing the documents is shared, allowing the ingested documents processing system 300 to access and ingest the documents seamlessly.

The data ingestor 114 is responsible for receiving and organizing the ingested documents 306. After ingestion, the documents 306 are passed on to the analyzer 116 for further analysis. This is where the content of document 306 is understood by the ingested documents processing system 300. During the pre-processing phase 308, the documents are parsed using a parsing module 118 (not shown in the figure) for filtering the relevant content from the ingested documents 306.

Once parsed, the analyzer 116 generates an action plan 310, which includes insights derived from the analyzed documents. For example, if the documents are related to a business project of an organization, the action plan could highlight key themes, topics, or potential actions for business growth based on the document content. This analysis feeds into the creation of a vector database 120, which is generated by embedding and chunking the analyzed documents. Embedding converts document content into numerical vectors, making it easier for the system to perform searches, categorization, and ranking. A priority score is assigned to the embedded documents using a ranking module 126, ensuring that the most relevant or critical documents are highlighted for the user.

A knowledge graph 312 is generated based on the most relevant or prioritized documents. This knowledge graph illustrates the relationships and connections between different entities, concepts, or documents, helping users understand the context and interconnections between the uploaded content.

An enriched query 314 or prompt is generated by a prompt generator 128, which utilizes rules and guidelines provided by a prompt engineer. This enriched query enhances the search or interaction capabilities by refining the user's prompt based on the analyzed documents. The enriched query is then processed by a large language model (LLM) 316, which interprets the query and generates intelligent responses based on the analyzed data.

The ingested documents processing system 300 then undergoes a phase of reflection 318 and post-processing 320, ensuring that the response is coherent, accurate, and aligned with the user's expectations. Finally, the document generator 132, integrated within the AI engine 130, produces a final response 322. For instance, if a user asked the ingested documents processing system 300 to summarize the contents of several uploaded PDFs, the final response would include a well-structured and coherent summary, drawing from the analyzed and prioritized content, enhanced by insights from the knowledge graph 312 and vector database 120.

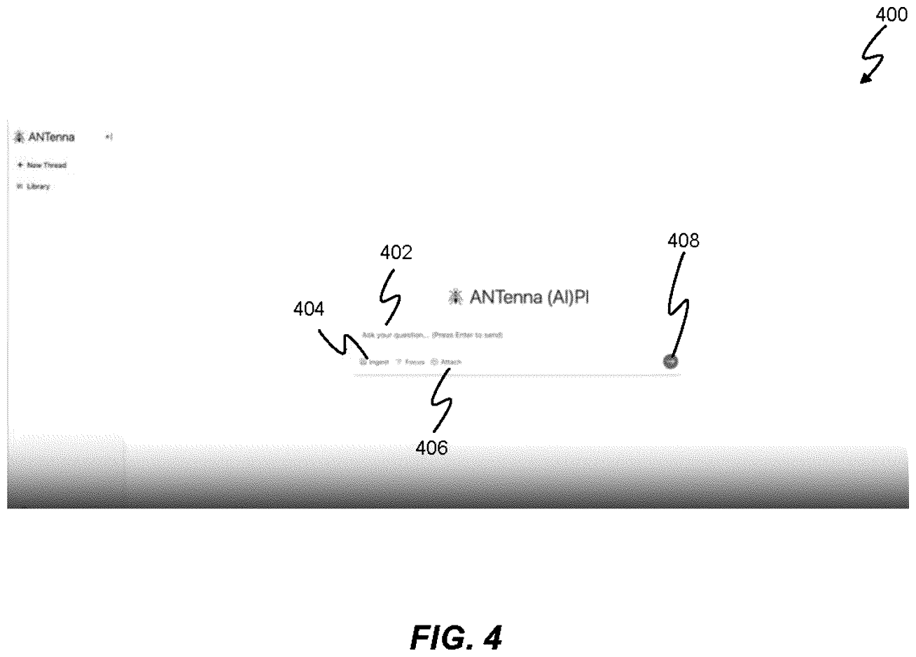

FIG. 4 depicts an exemplary user interface 400 where the user can either directly enter the query or ingest documents along with the query to get the result as per user requirements.

The user interface 400 displays the front page of the online document management platform 102. Upon logging on to the online document management platform 102, the user gets access to the user interface 400. The user can perform a plurality of tasks using the user interface 400, which includes, direct query submission without document ingestion, query submission along with document ingestion, only document ingestion, and so on.

The user can utilize the chatbot 106 integrated within the user interface 400 to type the query on tab 402. Further, the user can ingest and attach documents by clicking on the tabs 404 and 406 respectively. Finally, an arrow 408 is shown, using which the user can ask the online document management platform 102 to perform that task.

For instance, the user query may include:

```
{
  “namespace”: “drive_1ya3gwhzbo-eiit6sykkxulmaey-ufkid”,
  “query”: “What is required for R&D expenses to qualify for the Section
41 tax credit?”
}
```

Further, the document ingestion includes providing a link to the folder where the documents are stored. It could be local storage 108, within the device, or cloud storage 110, like, Google Drive, AWS S3, Microsoft One Drive, and so on. Like in the case of the above example of the user query, the link of the folder to be ingested is: drive_1ya3gwhzbo-eiit6sykkxulmaey-ufkid

In this way, it becomes very easy for the user to directly enter the query and upload the documents in the online document management platform 102 and receive a response instantly.

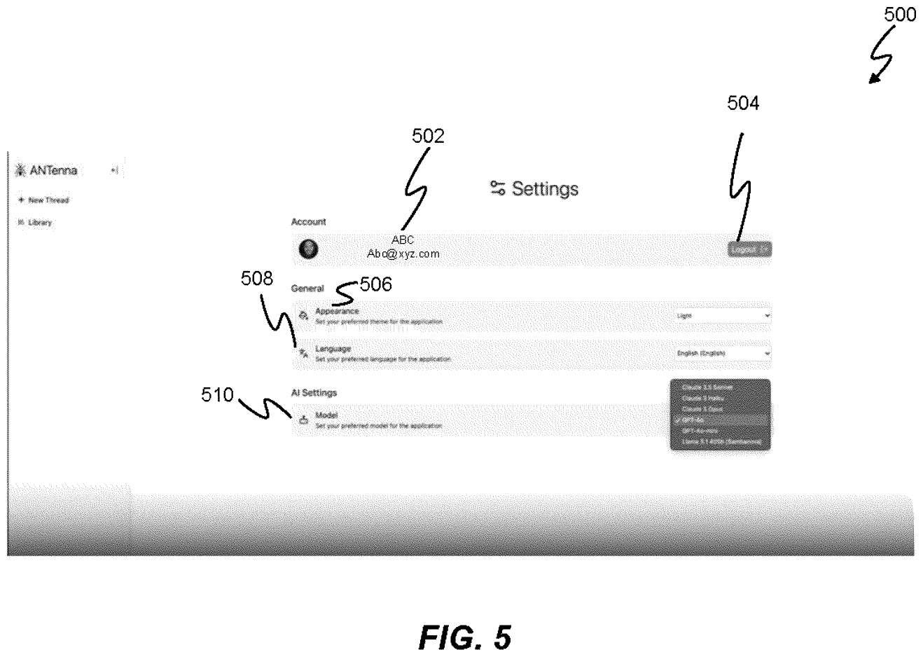

FIG. 5 depicts an exemplary user interface 500 that allows the user to change the settings of the online document management platform 102.

Upon clicking on the settings button given in the user interface 400, the user can access the settings of the online document management platform 102 and can make changes in the settings as per their requirements. The user interface 500 displays the settings of the online document management platform 102. The user details like name, photo, and email ID are mentioned in the tab 502. The user can adjust the general settings like the appearance and the language of the online document management platform 102. The appearance can be adjusted by clicking on tab 506, which involves a dropdown menu, including dark theme, light theme, colored theme, and so on. Similarly, the user uses the language settings by clicking on tab 508, which includes language selections like English (US), Hindi, English (UK), Chinese, and so on.

Further, the user can adjust the AI model settings, using which the user can select the AI engine 130 that they wish to use for completing the task prescribed by the user. The user can click on tab 510 to select the AI engine 130, as per their need. The settings include a dropdown menu where a plurality of AI tools are shown, which can be selected by the user. For instance, the AI tools mentioned in the dropdown menu include Claude 3.5 Sonnet, Claude 3 Haiku, GPT-4o, GPT-4o mini, Llama 3.1 405b Sambanova, and so on.

Claude 3.5 Sonnet is a model designed for generating detailed, structured responses, particularly effective for creative tasks like poetry or writing in constrained formats. Claude 3 Haiku is a more compact version, best suited for short, concise answers, especially useful in scenarios where brevity is key. GPT-4o is an optimized version of GPT-4, offering balanced performance across various tasks like problem-solving and conversation. GPT-4o mini is a lighter, faster variant of GPT-4o, ideal for quicker interactions and less complex tasks. Llama 3.1 405b, by Meta, is a powerful language model intended for both research and industrial applications, especially for handling large-scale language generation. Sambanova focuses on AI hardware and software solutions, facilitating high-performance AI workloads for enterprise and specialized tasks.

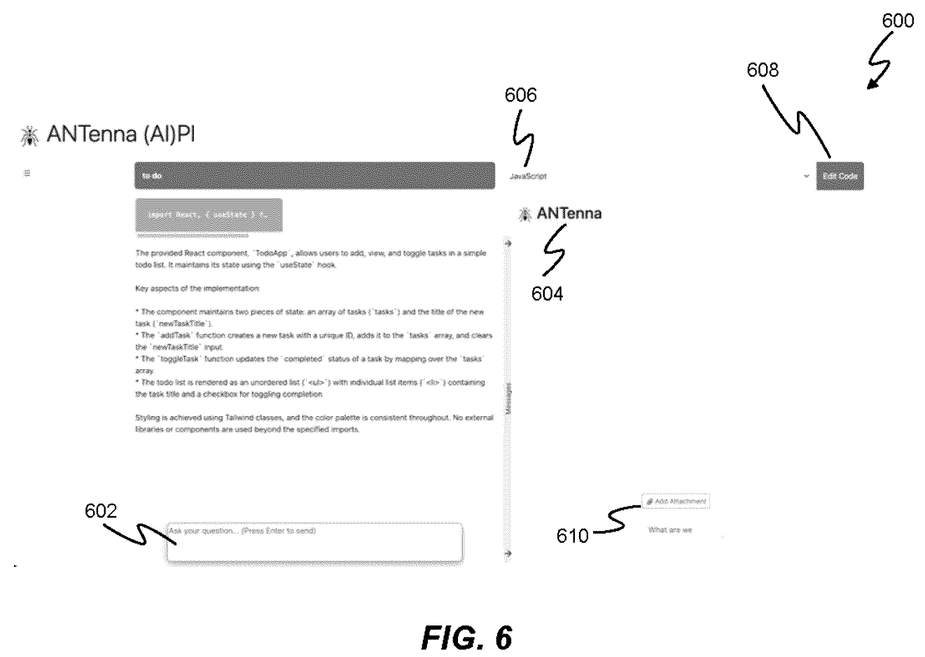

FIG. 6 depicts an exemplary user interface 600 where the user can query to generate a summarized document and access the application code used by the document processing module 112 to generate that summarized document.

The user submits a query via a chatbot 602, asking for a ToDo application 604 that allows the user to add, view, and toggle tasks in a simple to-do list. The query, such as ‘Please create a ToDo app that allows the users to add, view, and toggle tasks’, is processed by the AI engine 130. Based on this request, the AI engine 130 generates React code, a Javascript-based framework ideal for creating web applications, to build an application 604. This application 604 provides an interactive interface where the user can perform any task by querying the application 604, and the status of the task gets updated as soon as the task gets finished.

To create this application 604, the AI engine 130 uses documents provided by the user, accessed through an API link. These documents contain the necessary details, which are dynamically loaded into the drop-down menu. The application 604 offers several additional features to enhance usability. On the top-right corner of the screen, there are two tabs labeled ‘Javascript’ 606 and ‘Edit Code’ 608. These allow the user to either choose the programming language in which the code is generated by selecting from a drop-down menu or edit the code as generated by the AI engine 130.

On the left side of the screen, the React code used to generate the application 604 is displayed, providing transparency into how the AI engine 130 created the application 604. The user can further add new documents by clicking on the tab ‘Add Attachments’ 610, which allows the generated application 604 to perform its task.

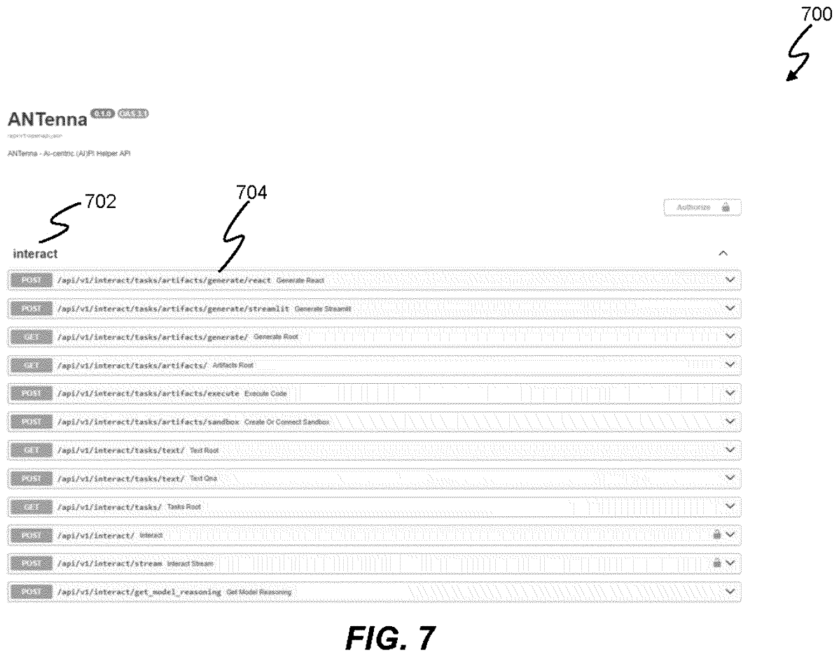

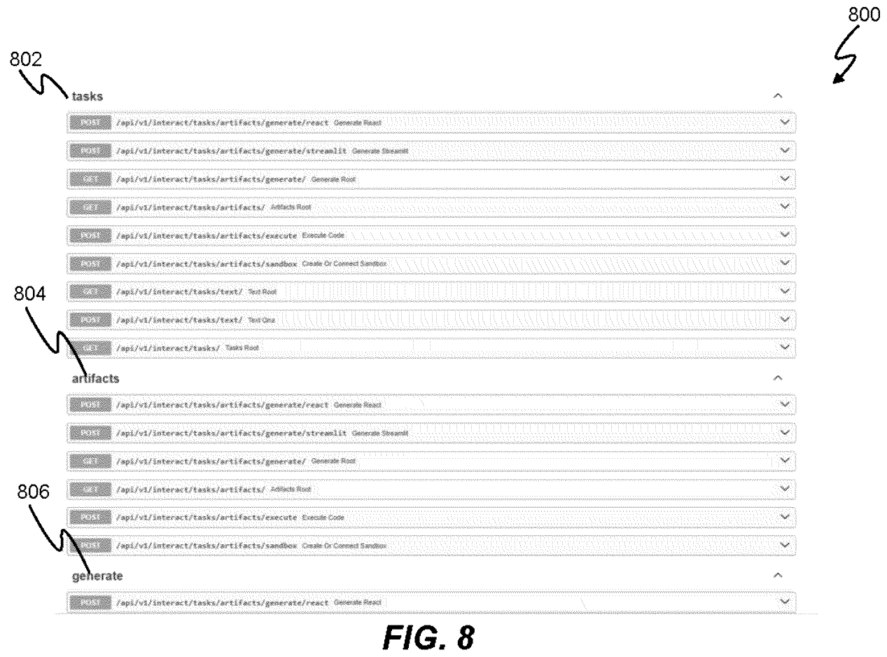

FIGS. 7 and 8 depict exemplary user interfaces displaying multiple API bundles using which the documents are ingested to the document processing module 112.

The user interface 700 discloses multiple API bundles categorized under different categories like interact 702, and so on. These categories include a plurality of API bundles within it to perform the task, as queried by the user. For instance, the task may include generating an application, generating a React Code, generating a Streamlit Code, and so on. The API bundles include the link to the folder provided by the user. The API bundles help in transmitting the document details from the corresponding folder to the data ingestor 114. For instance, an exemplary API bundle 704 includes ‘/api/v1/interact/task/artifacts/generate/React.’, where the user has queried to generate an application using React code. The user can click on the dropdown menu to enter the query.

React is a JavaScript library for building user interfaces and applications, especially for single-page applications, using reusable components, and managing dynamic data with state. React uses JSX, a syntax that blends HTML and JavaScript, to create interactive user interfaces and applications. On the other hand, Streamlit is a Python framework designed for quickly building web apps, particularly useful for data science and machine learning projects. The streamlit code allows users to create interactive elements like buttons and input fields with minimal code.

The user interface 800 discloses multiple API bundles categorized under different categories like tasks 802, artifacts 804, generate 806, and so on. These categories include a plurality of API bundles within it to perform the task, as queried by the user. For instance, the task may include generating an application, generating a React Code, generating a Streamlit Code, and so on.

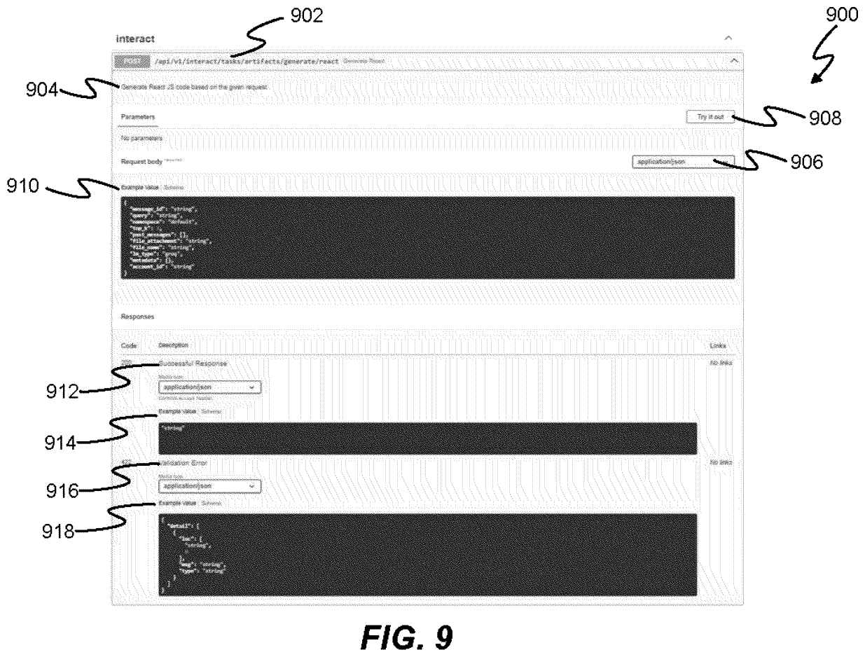

FIG. 9 depicts an exemplary user interface 900 that allows users to enter the query, for which the user needs a solution.

Upon clicking on the dropdown menu in the user interface 700, the user gets access to the user interface 900, where the user is allowed to enter the query. In the case of the present example, the user has accessed the dropdown menu of the API bundle ‘api/v1/interact/task/artifacts/generate/React.’ 902, where the user has queried for the generation of a React Code 904.

The user can select the type of input that they wish to provide from the dropdown menu 906. For instance, in the case of the present example, it is application/JSON. The user can further enter the query in the tab example value 910. Upon successfully entering the query, the user can click on tab 908 ‘Try it out’ to execute the query.

Further, the user receives the response generated by the AI engine 130, which includes a heading and a detailed description. The user can access the heading and detailed description of the response on the tabs 914 and 918 respectively. Additionally, the user can select the format of the headings and the detailed description of the response by clicking on the dropdown menus 912 and 916 respectively.

For instance, a link of the cloud storage 110, for instance, Google Drive, in the case of the present example is provided to the data ingester 134 vi., the API bundle 702 to retrieve a response to the user query. The function URL includes: https://vlq3xj5ppiykcsacw4wij5rlci0qfkom.lambda-url.us-east-1.on.aws/

The input, i.e., the link of the cloud storage 110 provided by the user on the tab 910 is given below:

```
{
  “namespace”: “drive_1ya3gwhzbo-eiit6sykkxulmaey-ufkid”,
  “query”: “What is required for R&D expenses to qualify for the Section
41 tax credit?”
}
```

The output generated based on the input provided by the user includes:

```
{
  ″message″: ″Success″,
  ″result″: {
    ″sources″: [
      {
        ″file_name″: ″Central Support - 2nd Brain NEW″,
        ″url″:
″https://docs.google.com/document/d/1vEANATZ38SIsuKtBus4TucpZLBLyVJw6ftm4X2hi
lqo/edit?usp=drivesdk″,
        ″mime_type″: ″application/vnd.google-apps.document″
      }
    ],
    ″response″: ″<text>\nThe note-taking app I'm about to generate will allow
users to create, edit, and save notes. The app will have a simple and
intuitive interface, making it easy for users to organize their thoughts and
ideas.\n\nHere's an overview of how the app will work:\n\n* Users can create
new notes by clicking on the \″New Note\″ button.\n* Each note will have a
title and a content area where users can type in their notes.\n* Users can
save their notes by clicking on the \″Save\″ button.\n* The app will display
a list of all saved notes, allowing users to easily access and edit their
previous notes.\n\nTo implement this app, I'll use React and Tailwind CSS for
styling. I'll create a ‘Note‘ component that will handle the creation,
editing, and saving of notes. The component will use React state to store the
note title and content. \n\nHere's an example of how the ‘Note‘ component
might look:\n‘‘‘jsx\nfunction Note( ) {\n const [title, setTitle] =
useState(′′);\n const [content, setContent] = useState(′′);\n\n const
handleSubmit = ( ) => {\n // Save the note to local storage or a database\n
};\n\n return(\n <div>\n <input\n type=\″text\″\n
value={title}\n onChange={(e) => setTitle(e.target.value)}\n
placeholder=\″Note title\″\n />\n <textarea\n
value={content}\n onChange={(e) => setContent(e.target.value)}\n
placeholder=\″Note content\″\n />\n <button
onClick={handleSubmit}>Save</button>\n </div>\n
);\n}\n‘‘‘\n</text>\n\<artifact>\n‘‘‘jsx\nimport React, { useState } from
′react′;\n\nfunction Note( ) {\n const [title, setTitle] = useState(′′);\n
const [content, setContent] = useState(′′);\n const [notes, setNotes] =
useState([ ]);\n\n const handleSubmit = ( ) => {\n const newNote = { title,
content };\n setNotes([...notes, newNote]);\n setTitle(′′);\n
setContent(′′);\n };\n\n const handleEdit = (index) => {\n const note =
notes[index];\n setTitle(note.title);\n setContent(note.content);\n
};\n\n const handleDelete = (index) => {\n setNotes(notes.filter((_, i)
=> i !== index));\n };\n\n return (\n <div className=\″flex flex-col h-
screen p-4\″>\n <h1 className=\″text-2xl\″>Note Taking App</h1>\n
<form onSubmit={(e) => e.preventDefault( )}>\n <input\n
type=\″text\″\n value={title}\n onChange={(e) =>
setTitle(e.target.value)}\n placeholder=\″Note title\″\n
className=\″w-full p-2 mb-2\″\n />\n <textarea\n
value={content}\n onChange={(e) => setContent(e.target.value)}\n
placeholder=\″Note content\″\n className=\″w-full p-2 mb-2\″\n
/>\n <button onClick={handleSubmit} className=\″bg-blue-500 hover: bg-
blue-700 text-white font-bold py-2 px-4 rounded\″>\n Save\n
</button>\n </form>\n <ul className=\″list-none p-0 m-0\″>\n
{notes.map((note, index) => (\n <li key={index} className=\″mb-
2\″>\n <h2>{note.title}</h2>\n <p>{note.content}</p>\n
<button onClick={( ) => handleEdit(index)} className=\″bg-yellow-500 hover:bg-
yellow-700 text-white font-bold py-2 px-4 rounded\″>\n Edit\n
</button>\n <button onClick={( ) => handleDelete(index)}
className=\″bg-red-500 hover:bg-red-700 text-white font-bold py-2 px-4
rounded\″>\n Delete\n </button>\n </li>\n
)}}\n </ul>\n </div>\n );\n}\n\nexport default
Note;\n‘‘‘\</artifact>″
  }
}
```

The output includes the details of an application generated by the user in JSON format. Further, the React code will be shown to the user along with the application generated, which can be accessed by the user to perform the function as needed.

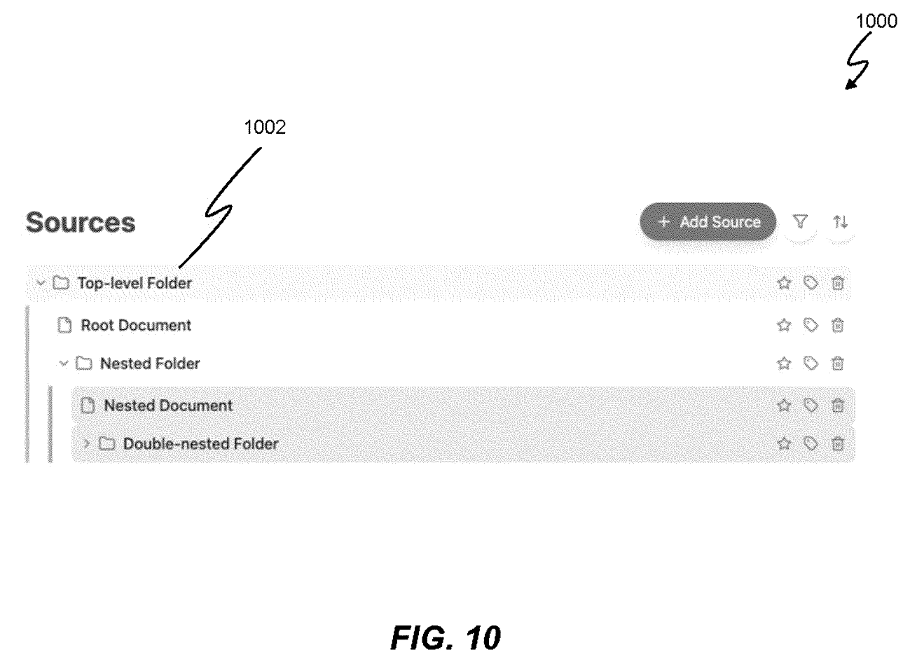

FIG. 10 depicts an exemplary user interface 1000 where the metadata-tagged and categorized documents are displayed to the user.

The user interface 1000 displays the list of the ingested documents that are provided by the user to the data ingestor 114 by using the API bundles 134. The ingested documents are metadata tagged in multiple categories based on the context, content, headings, semantic analysis, and so on. The tagged documents include a ‘Top-level Folder’ 1002, followed by the other folders like a root document, which include a nester folder. Further, the ‘Top-level Folder’ 1002 folder includes nested documents, which includes a double nested folder. The documents are arranged in a proper hierarchy involving priority order as well in which they are to be used when queried by the user.

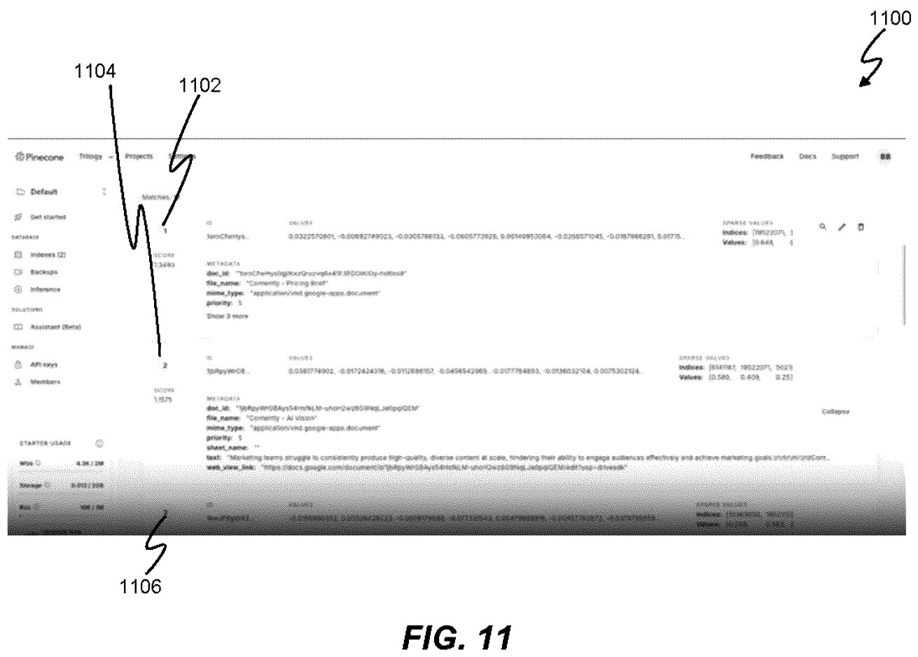

FIG. 11 depicts an exemplary vector database 1100 that provides the details of the metadata divided into chunks.

The vector database 120 is created by converting the content of one or more analyzed documents into vectorized embeddings using an embedding module 122 by converting all contextual data from the documents into numerical vectors that represent the semantic meaning of the text. The embedding utilizes machine learning algorithms to convert the textual content into vector embeddings, often represented in numerical format. These embeddings capture relationships between words, entities, and sections within the documents, making it easier to retrieve relevant information by understanding the semantic connections between different parts of the text.

In addition to embedding, the chunking module 124 breaks down the embedded content into smaller, meaningful chunks such as sections, paragraphs, or topics. This is based on semantic analysis, ensuring that each chunk represents a coherent idea or subject. By dividing the document into smaller units, it becomes easier to process and retrieve specific information, enabling more precise and efficient querying of the data. This structure enhances the retrieval of information by not only storing raw text but also understanding the relationships and meaning within the document.

For instance, in the case of the present example shown in FIG. 11, a plurality of vector databases 1100 are shown. The vector database 1102 includes details such as doc_id, file_name, mime_type, priority score, sheet_name, text, and web_view_link. The vector database 1102 also includes sparse values, including indices and values. Also, the vector database 1102 includes the converted numerical values generated by the embedding module 122.

The vector database 1102 is a wide-ranging data repository that stores various types of metadata and numerical representations of documents or content. The vector database 1102 includes several essential fields that help to organize and retrieve data efficiently. These fields include doc_id, which serves as a unique identifier for each document, and file_name, the name given to the file for easy identification. The mime_type field specifies the format of the file, indicating whether it is a text, image, or other file type. Additionally, the vector database 1102 tracks a priority score, which may be used to rank or prioritize certain documents for retrieval based on importance or relevance. For documents stored in spreadsheet formats, the sheet_name field identifies the specific sheet within the document. The text field contains the textual content of the file, allowing for easy search ability within the vector database. The web_view_link provides a URL or direct link to view the document in a web interface, enhancing accessibility.

In addition to the metadata, the vector database 1102 includes sparse values, which consist of pairs of indices and their corresponding values. These sparse values are typically representations of document features, where only non-zero or significant data points are stored, optimizing memory usage and processing speed. Furthermore, the vector database 1102 holds numerical values generated by the embedding module 122, which are converted representations of the document's content. These embeddings are derived from advanced machine learning models that transform textual or other data into dense numerical vectors, allowing for efficient similarity searches, clustering, and other data retrieval tasks. The inclusion of both sparse values and dense embeddings ensures that the vector database 1102 supports flexible, scalable, and precise data retrieval and analysis across a wide range of applications.

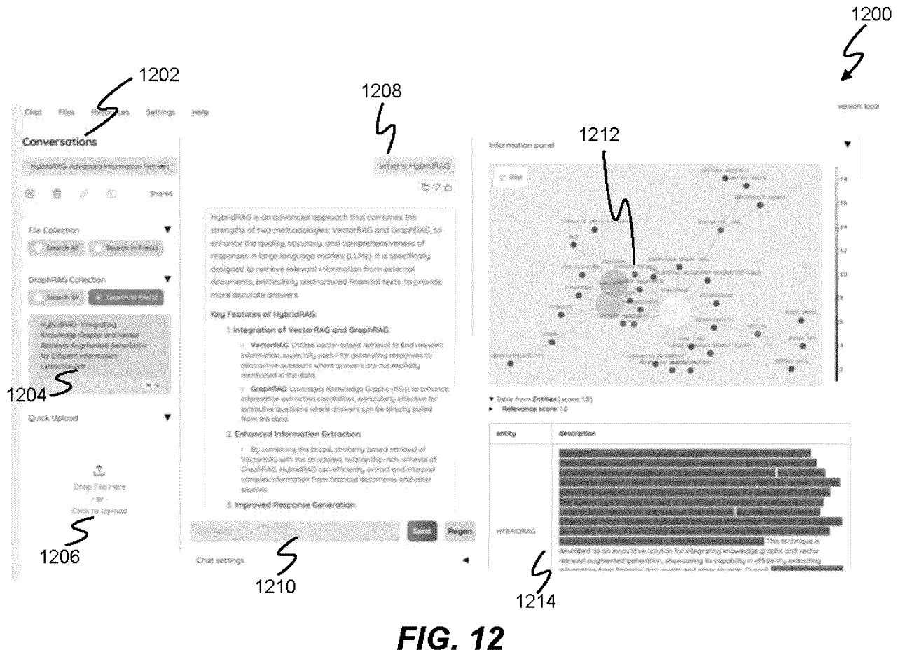

FIG. 12 depicts an exemplary knowledge graph 1200 generated based on the ingested documents and a user query.

The document ingestion system 100 includes automatically generating the knowledge graph 1212 related to prioritized documents involving creating a visual and data-driven representation that maps out the relationships, relevance, and interconnections between these documents. This knowledge graph 1212 serves as a structured way to organize and understand how various documents relate to one another based on their content. The prioritization of documents, typically determined by factors like relevance, importance, or freshness, determines which documents are featured most prominently in the graph. The knowledge graph 1212 highlights these relationships by connecting documents that share common themes, entities, or concepts, making it easier for users to navigate through the information and gain insights into the overall document structure.

The knowledge graph 1212 is constructed by analyzing the entities (such as people, places, or organizations) and concepts (such as ideas, themes, or topics) found within the documents. These entities and concepts are identified using natural language processing (NLP) techniques and form the nodes in the graph, while the relationships between them become the edges linking these nodes

Moreover, the knowledge graph 1212 is dynamic, meaning it evolves as new documents are ingested or existing ones are updated. When new documents are added, the analyzer 116 automatically analyzes their content, identifies relevant entities and concepts, and integrates them into the existing graph by creating new nodes and edges or updating existing ones. Similarly, if documents are modified or updated, the knowledge graph 1212 reflects these changes in real-time, ensuring that the interconnections and relevance of the documents are always accurate and up-to-date. This dynamic updating capability ensures that the knowledge graph 1212 remains an active and reliable tool for visualizing and understanding the ongoing flow of information.

For instance, the user can upload, edit, and delete the documents on the conversation area 1202. In the case of the present example, the user has uploaded a PDF document 1204 by clicking on the tab ‘Click to upload’ 1206. Further, the user can ask their queries using a chatbot 1210, integrated into the user interface, which displays the knowledge graph 1212. For instance, in the case of the present example, the user has asked a query, stating, ‘What is Hybrid RAG?’. The document generator 132 generates a response to the query asked by the user along with the knowledge graph 1212, based on the PDF document 1204 uploaded by the user. The details of the knowledge graph 1212 are also explained to the user in a tabular format 1214, which includes a description of various entities.

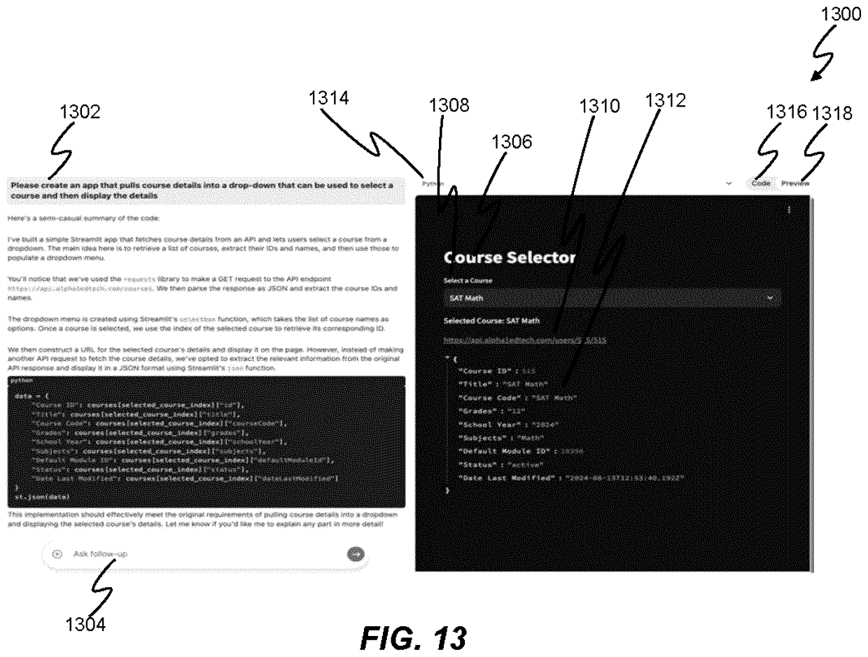

FIG. 13 depicts an exemplary scenario where the user queries the online document management platform 102 to generate an application 1306 using the ingested course details.

The user submits a query via a chatbot 1304, asking for an application 1306 that pulls course details into a drop-down menu for easy selection and displays the corresponding course information. The query, such as ‘Please create an app that pulls course details into a drop-down that can be used to select a course and then displays the details’, is processed by the AI engine 130. Based on this request, the AI engine 130 generates Streamlit code 1312, a Python-based framework ideal for creating web applications, to build an application named ‘Course Selector’ 1306. This application 1306 provides an interactive interface where the user can select a course from a drop-down menu labeled ‘Select a course’ 1308. In the given example, the course ‘SAT Maths’ is chosen from the drop-down.

To create this application 1306, the AI engine 130 uses documents provided by the user, accessed through an API link 1310. These documents contain the necessary course details, which are dynamically loaded into the drop-down menu. The application 1306 then displays the selected course's relevant information once a course is chosen, making it an efficient tool for users to browse and learn about different courses.

The application 1306 offers several additional features to enhance usability. On the top-right corner of the screen, there are two tabs labeled ‘Code’ 1316 and ‘Preview’ 1318. These allow the user to either view the underlying code that was generated to build the application 1306 or preview the actual functioning of the application 1306. This dual view enables users to see both the technical backend and the frontend result of their query. Furthermore, the user can also choose the programming language in which the code is generated by selecting from a drop-down menu 1314 located at the top of the interface. On the left side of the screen, the Streamlit code 1312 used to generate the application 1306 is displayed, providing transparency into how the AI engine 130 created the application 1306. This setup allows the user not only to interact with the app but also to understand and modify the code behind it. The user can make changes in application 1306, if the generated application 1306 is not as per the user's requirements by providing an additional query via., the chatbot 1304.

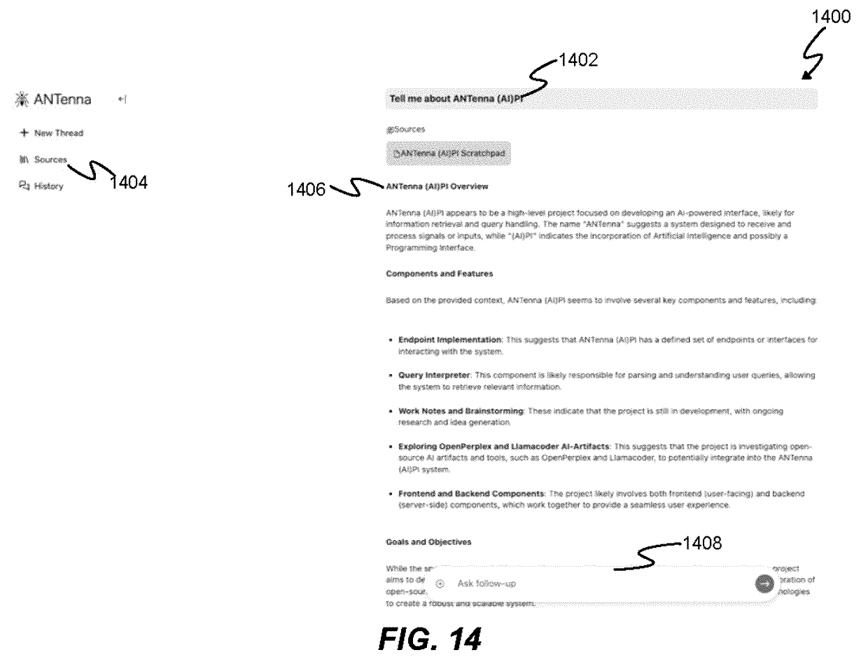

FIG. 14 depicts an exemplary scenario where the user queries the online document management platform 102 to generate a summary of the ingested document 1404.

When the user submits a query like ‘Tell me about ANTenna AI(PI)’ 1402 through a chatbot 1408, the AI engine 130 processes the request by utilizing the document generator 132. The document generator 132 utilizes the source data 1404 that the user has previously uploaded or provided, analyzing it to produce a relevant and informative response 1406. The document generator 132 extracts the necessary information from the provided data 1404 and delivers an accurate and structured reply to the user's query 1402.

The format of the generated response 1406 follows a specific JSON structure:

Response JSON Structure
<Node>
ID
Title
Url
[Tags] - Priority, etc.
{Storage}
Pinecone Namespace
Graph Key
[Children]

Each node contains key metadata and organizational details about the queried topic. The structure of response 1406 includes the following elements, namely, ID, Title, Url, Tags, Storage, Pinecone Namespace, Graph Key, and Children. The ID is a unique identifier assigned to the specific piece of information or document being referenced. The Title is the title or heading of the document or section related to the query, providing an immediate summary of the content. The Url is a link or URL that directs the user to the source of the document or additional relevant information, enabling further exploration.

Further, Tags are a list of categories associated with the document, such as Priority, Urgent, Important, or other relevant keywords, that categorize or rank the importance of the content, helping the ranking module 126 or the user prioritize certain documents over others. Also, the ranking can be provided based on the freshness of the documents. Storage is a field that refers to the storage location or type of repository where the document 1404 or data is stored, ensuring easy retrieval. The Pinecone Namespace is used for managing vector embeddings. This field specifies the namespace within the Pinecone database that holds the vector embeddings related to the documents, facilitating efficient and relevant searches within the dataset.

Additionally, the Graph Key is used to link document 1404 or data into a larger knowledge graph, connecting it to other related documents or concepts. The graph key helps in understanding relationships between pieces of information. Finally, Children is a list of child nodes or sub-documents that are linked to the main node. These could represent related documents, subtopics, or more detailed breakdowns of the information, creating a hierarchical structure.

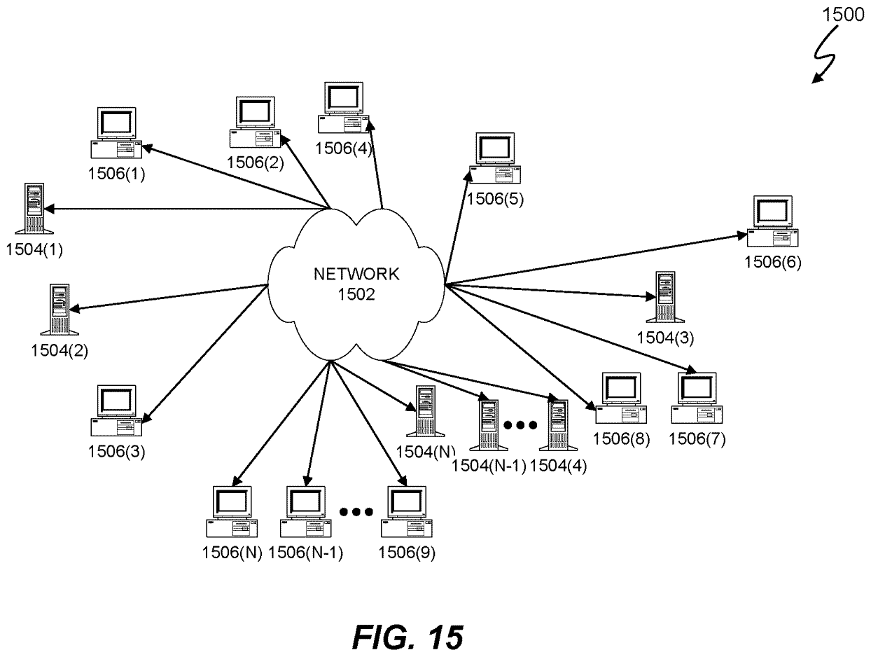

FIG. 15 is a block diagram illustrating a network environment in which a document ingestion system 100 and process 200 that manage documents and generates a summarized document using a user query may be practiced. Network 1502 (e.g. a private wide area network (WAN) or the Internet) includes several networked server computer systems 1504(1)-(N) that are accessible by client computer systems 1506(1)-(N), where N is the number of server computer systems connected to the network. Communication between client computer systems 1506(1)-(N) and server computer systems 1504(1)-(N) typically occurs over a network, such as a public switched telephone network over asynchronous digital subscriber line (ADSL) telephone lines or high-bandwidth trunks, for example, communications channels providing TI or OC3 service. Client computer systems 1506(1)-(N) typically access server computer systems 1504(1)-(N) through a service provider, such as an internet service provider (“ISP”) by executing application-specific software, commonly referred to as a browser, on one of client computer systems 1506(1)-(N).

Client computer systems 1506(1)-(N) and/or server computer systems 1504(1)-(N) are specialized computers programmed to improve conventional computer systems to implement and utilize the document ingestion system 100 and process 200 that manage documents and generates a summarized document using a user query. The type of computer system that can be specially programmed to implement and utilize the document ingestion system 100 and process 200 that manage documents and generate a summarized document using a user query includes a mainframe, a mini-computer, a personal computer system including notebook computers, a wireless, mobile computing device (including personal digital assistants, smartphones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the document ingestion system 100 and process 200 that manage documents and generate a summarized document using a user query can be implemented using code stored in a tangible, non-transient computer-readable medium and executed by one or more processors. In at least one embodiment, the document ingestion system 100 and process 200 that manage documents and generate a summarized document using a user query can be implemented completely in hardware using, for example, logic circuits and other circuits including field programmable gate arrays.

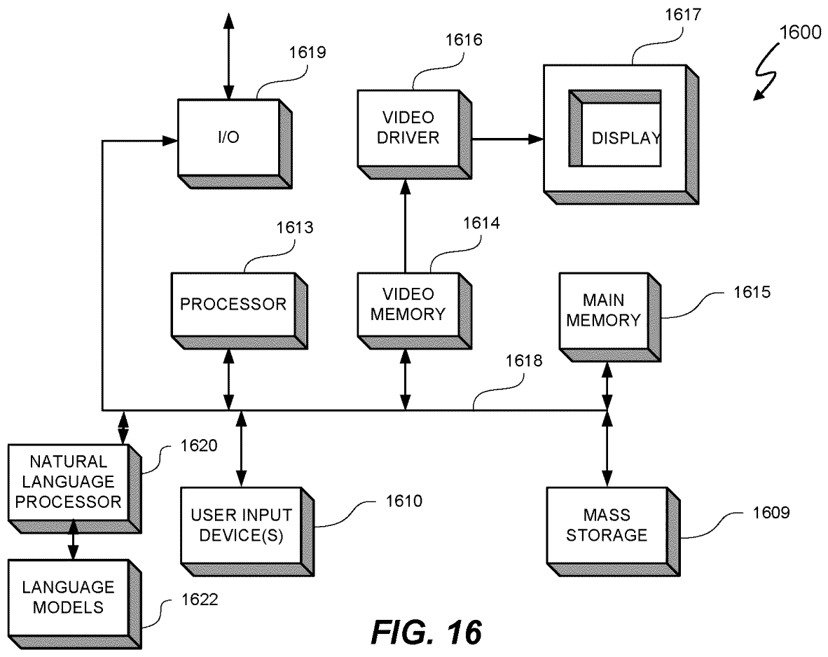

Embodiments of the document ingestion system 100 and process 200 that manage documents and generate a summarized document using a user query can be implemented on a computer system such as a special-purpose, special-programmed computer 1600 illustrated in FIG. 16. The input user device(s) 1610, such as a keyboard and/or mouse, are coupled to a bi-directional system bus 1618. The input user device(s) 1610 are for introducing user input to the computer system and communicating that user input to the processor 1613. The computer system of FIG. 16 generally also includes a non-transitory video memory 1614, non-transitory main memory 1615, and non-transitory mass storage 1609, all coupled to the bi-directional system bus 1618 along with input user device(s) 1610 and processor 1613. The mass storage 1609 may include both fixed and removable media, such as a hard drive, one or more CDs or DVDs, solid state memory including flash memory, and other available mass storage technology. Bus 1618 may contain, for example, 32 of 64 address lines for addressing video memory 1614 or main memory 1615. The system bus 1618 also includes, for example, an n-bit data bus for transferring DATA between and among the components, such as CPU 709, main memory 1615, video memory 1614, and mass storage 1609, where “n” is, for example, 32 or 64. Alternatively, multiplex data/address lines may be used instead of separate data and address lines.

I/O device(s) 1619 may provide connections to peripheral devices, such as a printer, and may also provide a direct connection to a remote server computer system via a telephone link or to the Internet via an ISP. I/O device(s) 1619 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 1609, into main memory 1615 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1613, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1615 consists of dynamic random access memory (DRAM). Video memory 1614 is a dual-ported video random access memory. One port of the video memory 1614 is coupled to the video amplifier 1616. The video amplifier 1616 is used to drive the display 1617. Video amplifier 1616 is well-known in the art and may be implemented by any suitable means. This circuitry converts pixel DATA stored in video memory 1614 to a raster signal suitable for use by display 1617. Display 1617 is a type of monitor suitable for displaying graphic images.

The computer system described above is for purposes of example only. The document ingestion system 100 and process 200 that manage documents and generate a summarized document using a user query may be implemented in any type of computer system or programming or processing environment. It is contemplated that the document ingestion system 100 and process 200 that manage documents and generate a summarized document using a user query might be run on a stand-alone computer system, such as the one described above. The document ingestion system 100 and process 200 that manage documents and generate a summarized document using a user query might also be run from a server computer system that can be accessed by a plurality of client computer systems interconnected over an intranet network. Finally, the document ingestion system 100 and process 200 that manage documents and generate a summarized document using a user query may be run from a server computer system that is accessible to clients over the Internet.

Although embodiments have been described in detail, it should be understood that various changes, substitutions, and alterations can be made herein without departing from the spirit and scope of the invention as defined by the appended claims.

1. A method of ingestion of one or more documents to generate a summarized document by utilizing a user query, the method comprises:
executing code using one or more processors of a computer system to cause the computer system to perform operations comprising:
automatically ingesting one or more documents from multiple sources, wherein the multiple sources include local storage or cloud storage;
analyzing the ingested one or more documents to assign metadata tags by utilizing natural language processing techniques, wherein the analysis of the ingested one or more documents involves extracting and parsing relevant text from the ingested one or more documents;
generating a vector database which utilizes the analyzed one or more documents by:
converting the one or more parsed document content into vectorized embeddings, wherein the conversion involves converting all contextual data in the documents in numerical format; and
chunking the embedded document content into smaller, coherent chunks based on semantic analysis, such as sections, paragraphs, or topics, to facilitate more granular processing and retrieval;
providing a ranking to each chunked documents by classifying the chunked documents into predefined categories, including, content, context, and semantic analysis, and prioritizing the classified one or more documents by generating a priority score for each document, wherein the prioritization denotes the relevance and importance of the one or more documents;
generating a prompt to guide the AI engine to process the prioritized documents to generate the summarized document or answer the user query, wherein the user query is provided by the user in the form of a natural language input that is easy to understand by the AI engine;
transferring the generated prompts to the AI engine to pre-process the prioritized documents to generate application codes and the summarized document, as queried by the user;
generating the summarized document at various fidelity levels for the ingested documents to create an adaptive mechanism that can use document prioritization, wherein the summary provides a concise answer to the user queries, with varying levels of detail depending on the depth of the information required.

2. The method of claim 1 wherein the one or more ingested documents are available in multiple formats, including, PDF, text files, spreadsheets, emails, messages, JSON, and so on.

3. The method of claim 1 wherein the analysis of the ingested documents further comprises:
utilizing NLP techniques to identify and extract key terms, and entities, including names, places, dates, and relationships within the ingested documents;
performing semantic analysis to understand the content and context of the ingested documents.

4. The method of claim 1 wherein the embedding involves:
utilizing machine learning algorithms to convert the analyzed document's textual contents into vector embeddings that include numerical format;
encoding relationships between words, entities, and sections of the documents, allowing easy retrieval of information from the documents.

5. The method of claim 1 wherein the prioritization of the one or more classified documents is done based on source reliability, content importance, or freshness of the information.

6. The method of claim 1 wherein the priority score is allocated to each document during the prioritization of the one or more classified documents.

7. The method of claim 1 wherein the documents with a priority score less than 3 are ignored or not considered for the knowledge graph generation.

8. The method of claim 1 wherein the priority scores are utilized during information retrieval to rank documents, ensuring that higher-priority information is retrieved first in response to user queries, thereby improving the relevance of search results.

9. The method of claim 1 further comprises:
removing the documents with a high priority score from the list of ingested documents;
re-ranking the left documents by utilizing LLM tools;
combining the re-ranked documents with the documents with high priority scores.

10. The method of claim 1 further comprises:
automatically generating a knowledge graph by utilizing the prioritized documents, wherein the knowledge graph indicates the relevance and interconnectivity between the documents.

11. The method of claim 1 wherein the knowledge graph is constructed by identifying relationships between entities and concepts within the documents to create nodes and edges in the graph that link related documents, enhancing the understanding of document context and interconnectivity.

12. The method of claim 1 wherein the multiple fidelity levels to generate the summarized documents include full raw context, detailed summary, concise summary, and key facts and entities.

13. The method of claim 1 wherein the generation of the application code further comprises:
generation of executable application code snippets and detailed explanations of the codes based on prioritized documents or user queries.

14. The method of claim 1 wherein the application code includes React Code, Streamlit Code, and so on.

15. A system to ingest one or more documents to generate a summarized document by utilizing a user query provided by the user in an online document management platform comprises:
one or more processors of a computer system;
memory, coupled to the one or more processors, that store code and execution of the code by the one or more processors causes the computer system to perform operations comprising:
automatically ingesting one or more documents from multiple sources using a data ingester, wherein the multiple sources include local storage or cloud storage;
analyzing the ingested one or more documents to assign metadata tags by using an analyzer that utilizes natural language processing techniques, wherein the analysis of the ingested one or more documents involves extracting and parsing relevant text from the ingested one or more documents using a parsing module;
generating a vector database which utilizes the analyzed one or more documents by:
converting the one or more parsed document content into vectorized embeddings using an embedding module, wherein the conversion involves converting all contextual data in the documents in numerical format; and
chunking the embedded document content into smaller, coherent chunks based on semantic analysis, such as sections, paragraphs, or topics, to facilitate more granular processing and retrieval by using a chunking module;
providing a rank to each chunked document using a ranking module by classifying the chunked documents into predefined categories, including, content, context, and semantic analysis; and prioritizing the classified one or more documents by generating a priority score for each document, wherein the prioritization denotes the relevance and importance of the one or more documents;
generating a prompt using a prompt generator to guide the AI engine to process the prioritized documents to generate the summarized document or answer the user query, wherein the user query is provided by the user in the form of a natural language input that is easy to understand by the AI engine;
transferring the generated prompts to the AI engine to pre-process the prioritized documents to generate application codes and the summarized document, as queried by the user;
generating the summarized document at various fidelity levels for the ingested documents to create an adaptive mechanism that can use document prioritization by using a document generator, wherein the summary provides a concise answer to the user queries, with varying levels of detail depending on the depth of the information required.

16. The system of claim 15 wherein the summarized documents are made available to the user on a user interface integrated within the online document management platform.

17. The system of claim 15 wherein the analyzer utilizes advanced Natural Language Processing (NLP) techniques to extract key terms, entities, and relationships from the ingested documents, providing enhanced metadata tagging that categorizes the documents based on their content, relevance, and context.

18. The system of claim 15 wherein the parsing module extracts relevant text from various document formats, including PDFs, text files, and spreadsheets, ensures that different file types can be processed and analyzed seamlessly.

19. The system of claim 15 wherein the ranking module generates a priority score for each chunked document based on factors such as source reliability, content importance, or freshness of the information.

20. The system of claim 15 wherein the priority score is allocated to each document during the prioritization of the one or more classified documents.

21. The system of claim 15 wherein the documents with a priority score less than 3 are ignored or not considered for the knowledge graph generation.

22. The system of claim 15 wherein execution of the code by the one or more processors causes the computer system to perform further operations comprising:
automatically generating the knowledge graph related to the prioritized documents, wherein the knowledge graph indicates the relevance and interconnectivity between the documents.

23. The system of claim 15 wherein the knowledge graph updates dynamically as new documents are ingested or existing documents are modified.
